(19) United States
(12) Patent Application Publication
(10) Pub. No.: US 2012/0143495 A1
(43) Pub. Date: Jun. 7, 2012

(54) METHODS AND SYSTEMS FOR INDOOR NAVIGATION

(75) Inventor: Ramanamurthy Dantu, Richardson, TX (US)

(73) Assignee: The University of North Texas, Denton, TX (US)

(21) Appl. No.: 13/273,142

(22) Filed: Oct. 13, 2011

Related U.S. Application Data
(60) Provisional application No. 61/393,240, filed on Oct. 14, 2010.

(51) Int. Cl. G01C 21/00; H04W 24/00; G01C 21/16

(52) U.S. Cl. 701/428; 701/526; 701/500; 701/409; 455/457

(57) ABSTRACT

Methods and systems for indoor navigation utilize a smartphone equipped with various sensors. When a person whose initial position is unknown, and in some circumstances whose sight has been impaired, specifies a destination, the navigation system will calculate the coordinates of his/her present location from the sensor readings. It will then calculate the distance to be traveled to the destination and form routes to direct him/her towards the desired location. These steps are carried out using sensor readings and in some cases magnetic maps of the interiors of buildings stored on the smartphone. In some cases dynamic time warping (“DTW”) is used to align a recorded signature of the person's movement through the building with a stored magnetic map in order to identify the person's location within the building.

This application claims priority to U.S. Provisional Patent Application Ser. No. 61/393,240, entitled METHODS AND SYSTEMS FOR INDOOR NAVIGATION, filed on Oct. 14, 2010, the entire content of which is hereby incorporated by reference.

### BACKGROUND

This invention pertains to methods and systems for indoor navigation, particularly during times of visual impairment, using a smartphone equipped with sensors.

Visual impairment can be caused by accidents, medications, color blindness and other factors. Even poor illumination can hinder sight for certain people, thereby making navigation in such conditions difficult. Darkness or reduction of lighting levels in buildings can happen due to complete power outages, unexpected fire incidents and mechanical failures. People panic during these situations trying to find their way in the dark. Walking in the dark or poor lighting conditions, finding or reaching objects at home or the office at night are general scenarios that people (young and elderly) with vision find difficult. Without sufficient visual support, sighted people operating in the dark tend to lose their balance, with the subsequent sway that arises, coupled with disorientation, eventually causing them to lose track of their current location or intended destination.

Indoor localization is the problem of identifying and locating a user inside a building. GPS typically does not work indoors, WiFi may not be omnipresent, and wearable sensor systems are not practically feasible.

### SUMMARY

The present invention relates generally to methods and systems for indoor navigation and localization, particularly during times of visual impairment, using a smartphone that is equipped with various sensors.

Mobile smartphones today are equipped with numerous sensors like accelerometers, compasses, light and temperature sensors, and microphones, making them simple multimodal devices capable of sensing different kinds of data such as physical, magnetic, acoustic and optical. These sensors are monolithic and do not depend on or interact with each other, which is different compared to sensors in a sensor network that are distributed, dependent upon or interact with each other. Wireless sensor networks, a network of cameras, infrared sensors and so on are examples of wireless sensor networks. A multitude of applications are now practically feasible with on-board sensors contained within the smartphones currently possessed by numerous members of the public. For instance, activity monitoring using accelerometers is possible, as is localization and tracking using a compass.

The present methods and systems for indoor navigation are adaptive to different environments and people, capable of tracking locations and identifying indoor landmarks along corridors, pathways, and other such areas. Tracking involves estimating the location coordinates based on multiple sensor outputs like those of a compass and accelerometer. Multi sensor data fusion is the amalgamation of outputs from multiple sensors to infer something beneficial. The advantages of fusion are improved quality of information output, improved estimate of a physical phenomena and environment, increased accuracy and so on. Potential applications range from military applications, such as missile surveillance, target detection, and military units identification, to non-military applications such as robot localization and tracking, automated control of industrial manufacturing systems and medical diagnosis. Fusion depends upon the type of sensors, the application domain and the sensor suite.

Outdoor landmarks like intersections, rivers, famous buildings, and such, aid people in reaching their destination at new places. Similarly indoor navigation also requires landmarks that could help in finding the right office, classroom and so on. Structures like pillars, are characterized by different values of magnetic field strengths. These pillars or wayposts are set up as reference locations thereby serving as aids for navigation. Magnetic and electric fields are produced by any wiring or equipment carrying electric current. This includes overhead and underground power lines carrying electricity, wiring in buildings and electrical appliances. Magnetic anomalies inside buildings arise from ferromagnetic materials such as iron, steel and reinforced concrete pillars, elevators, vending machines, electrical and mechanical equipments etc. Ambient magnetic signature are a combination of the Earth's magnetic field, the anomalies, and noise. The strengths of the fields decrease rapidly with increasing distance from the source. Although extensive research has not shown any obvious health effects on humans, it is still useful to have an approximate idea of the field strengths when entering and traversing buildings, research laboratories, and places using heavy machinery.

The present methods and systems for indoor navigation differ are distinctive due to the use of a single measuring device, a mobile smartphone. All sensors are embedded and easily accessible using a suitable platform. Exhaustive sets of data must be collected from the mobile phone's on-board sensors inside different buildings and corridors to fully establish the indoor navigation system. This data has also been collected to thoroughly validate the sensitivity, reliability, and robustness of the phone's built in sensors.

The present methods and systems for indoor navigation must, necessarily, function indoors. However, navigation systems that might be used indoors often have the possibility of major technical issues such as radio signal strength fluctuations, susceptibility of ultrasound to shadowing, computational and power burden placed on receivers due to processing of different signals, and the high installation cost. GPS technology in itself has a major problem in that it cannot function indoors due to multipath reflection and signal blockage from buildings resulting in signal attenuation. The current methods and systems avoid these problems, are not reliant on infrastructure modifications, and are simple and easy to use.

Overall, the present indoor navigation system uses a mobile phone with its built-in sensors to (1) track the location of a person indoors, (2) identify landmarks along different corridors and (3) understand the cognitive and wayfinding skills of sighted humans. It also formulates multi sensor fusion models for these kinds of sensors and can be used to develop magnetic field maps of the building being navigated.

In certain instances, the present indoor navigation system can work as follows: When a person whose initial position is unknown specifies a destination, the navigation system will calculate the coordinates of his/her present location from the sensor readings. It will then calculate the distance to be traveled to the destination and form routes to direct him/her towards the desired location. This involves periodic synchronization of the person's position in the building. The system should also generate alerts, such as audio based alerts, about the turns to be taken and the landmarks present along the way, similar to the GPS systems used for road navigation.

For example, a scenario can be envisioned where a user walks a few meters in an unknown hallway, then uses his mobile phone to estimate his location and position in that hallway using the magnetic signature. First each hallway must be fingerprinted using its magnetic signature. Then by classifying the test signature of an unknown hallway to one of the fingerprints, person's location can be obtained and his position estimated in meters, thereby providing fine grained localization. However, differences in human walking speeds cause variations in the time and magnitude of signatures, even if they retain the same pattern. Hence the dynamic time warping (DTW) classifier should be incorporated which is known to account for these differences and perform alignment by stretching or compressing the signals. A smart phone based novel solution is described herein for indoor localization using magnetic fields. Presently, no work in the literature has utilized the magnetic field sensor as a magnetometer to capture the anomalies and utilize them directly for localization.

Existing work requires sensors to be interfaced with laptops or base stations that have to be placed strategically or sytems that pose constraints on the placement and orientation. There is also infrastructure, installation and maintenance cost associated with certain solutions. In contrast to all these existing systems, the present methods represent a fine localization application utilizing just a smart phone. This work does not pose any placement or orientation constraints, is practically implementable on smart phones with different hardware and most importantly performs localization independent of the subject and his/her walking speed.

The proposed localization method described herein has the following properties:

1. Encapsulated in a single sensing unit, requires no external device or infrastructure.

2. Position and orientation invariant.

3. Ability to work over a variety of users.

By employing the built-in magnetic sensor as a magnetometer, the uniqueness of magnetic signatures of different hallways has been shown. By applying time warping technique to these magnetic signatures, it has also been shown that the present classification framework is independent of the user and also the phone used. The classification accuracies indicate that hallways could be distinguished with a good success rate. Short localization distances and low estimation errors are very encouraging and show the feasibility of this approach. The faster response times, low memory and power consumption indicate the successful implementation of dynamic time warping algorithm on resource limited smartphones.

### BRIEF DESCRIPTION OF THE DRAWINGS

FIG. 1 shows a representation of a high level architecture of one embodiment of the current indoor navigation system.

FIG. 2 shows a plot of time versus pressure recorded when a tactile sensor came into contact with different objects.

FIG. 3 shows the signal strength of four different devices recorded at different distances.

FIG. 4 shows the relationship of the azimuth to the X-axis and how it is recorded by the orientation sensor.

FIG. 5 shows a screen shot of one embodiment of a software application that can be used in the indoor navigation system.

FIG. 6 shows an integrated plot of time versus accelerometer data and compass data.

FIG. 7 shows distance estimation plots (a) for estimated and measured distance without data fusion and (b) for estimated and measured distance with data fusion.

FIG. 8 shows an average error comparison between fused and unfused results for various particle sizes.

FIG. 9 shows trajectory estimation (a) without fusion, (b) with fusion, and (c) with fusion for four turns.

FIG. 10 shows a plot of distance versus variations in magnetic field for an individual walking past pillars in an indoor corridor.

FIG. 11 shows a map of magnetic field strength for the length of a corridor having various pillars and the width of the corridor.

FIG. 12 shows a map of distance versus magnetic flux in a corridor using different measuring devices and showing guideposts.

FIG. 13 shows a map of magnetic field intensities of pillars on both sides of a corridor.

FIG. 14 shows a hysteresis loop of magnetic flux density and magnetizing force.

FIG. 15 shows an equation diagram representing a structured pillar and its dimensions.

FIG. 16 shows a plot of magnetic field distribution of a pillar's measured data and a theoretical model.

FIG. 17 shows magnetic field distributions for a pillar at different times of the day.

FIG. 18 shows profiles of magnetic field data collected in four different locations (a)-(d).

FIG. 19 shows magnetic field strength anomalies and compass headings versus time.

FIG. 20 shows time versus recorded magnetic field strength for two different measuring devices.

FIG. 21 shows plots of time versus acceleration for two subjects (a) and (b).

FIG. 22 shows time versus heading for two subjects navigating a turn.

FIG. 23 shows original distance versus amount of over estimated and under estimated distance.

FIG. 24 shows a plot of index of difficulty versus mean time showing how the Fitt's model is applied to underestimation measurements.

FIG. 25 shows the variance of magnetic signature of a hallway.

FIG. 26 shows the effects of distance on magnetic signature.

FIG. 27 shows effects of phone placement location on magnetic signature.

FIG. 28 shows magnetic signatures from two different phones.

FIG. 29 shows signature variation along the time and magnitude axis (a).

FIG. 30 shows a test signature and map for a sliding windowed DTW.

FIG. 31 shows a schematic of the classification system described in this disclosure.

FIG. 32 shows floor maps, with paths AB, DC, DE, and EF showing the hallways where data collection and system evaluation were performed.

FIG. 33 shows the application of the sliding windowed DTW on measurement data, with (a) and (d) being maps, (b) and (e) being short test signatures, and (c) and (f) being test signatures matched to the correct segment in the map.

FIG. 34 shows estimation errors as a function of window size or resolution.

### DETAILED DESCRIPTION OF PREFERRED EMBODIMENTS

Generally, the present invention relates to methods and systems for indoor navigation utilizing a mobile smartphone, particularly for use in times of visual impairment.

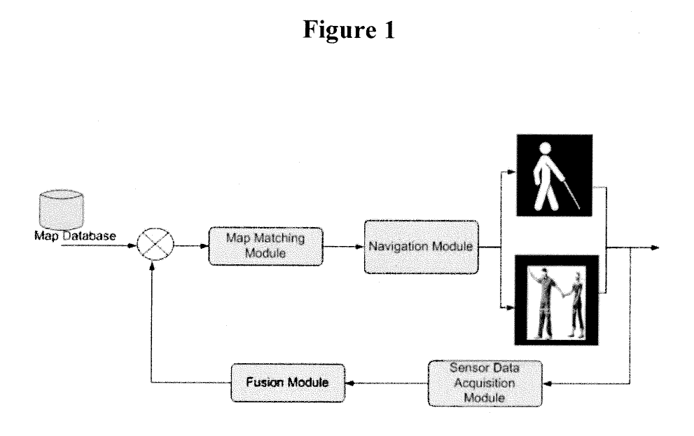

FIG. 1 shows a general representation of the overall, high-level architecture of one embodiment of the indoor navigation system.

The individual in need of indoor navigation should have in their possession, and on their person, a mobile smartphone having the appropriate sensors, software platform, and modules. Once navigation is to begin, the sensors are activated using an appropriate software program installed on the smartphone.

A preferred device that can be used to carry out the methods described herein includes a smartphone that is equipped with various sensors such as an accelerometer, a compass, and a magnetic field sensor. Examples include an ANDROID based smartphone, the NEXUS ONE (Google Inc. Mountainview, Calif.), or the G1 phone by HTC (Taiwan). Phones operating similar platforms will make it relatively easy to measure and acquire data to be analyzed thoroughly. Given their mobility and rise in popularity the past few years, smartphone-based measuring devices make the present methods and systems unique and applicable for future implementations.

With regard to FIG. 1 and the overall architecture of the indoor navigation system, the sensor data acquisition module collects the raw sensor readings, such as accelerometer, compass, and magnetometer readings, and preprocesses it. The data is then incorporated into the data fusion module. The particle filter that is part of the fusion module then uses the data to produce desired estimates, such as estimates of the distance traveled and the coordinates or location of the individual. The map matching module then identifies the location of the person by comparing the tracked coordinates with the building coordinates obtained from the map database. The navigation module is responsible for calculating the route to the destination using routing algorithms and generating alerts, including voice based alerts, about the turns to be taken and the distance remaining to reach a destination.

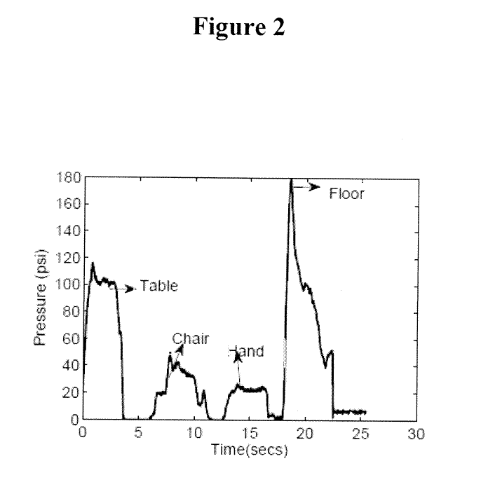

Another embodiment could also utilize a tactile sensor connected to a long device, such as a cane, that is typically used by visually impaired individuals for mobility purposes. The tactile sensor is located at the end of the device and transfers the pressure information recorded when it comes in contact with objects to the mobile smartphone through a wireless connection such as Bluetooth. After interpretation of the recorded data, this information would further be sent to the navigation module which would alert the individual about the obstacles. FIG. 2 shows the pressure values recorded when the sensor came in contact with different objects, such as the floor, table, chair, human hand.

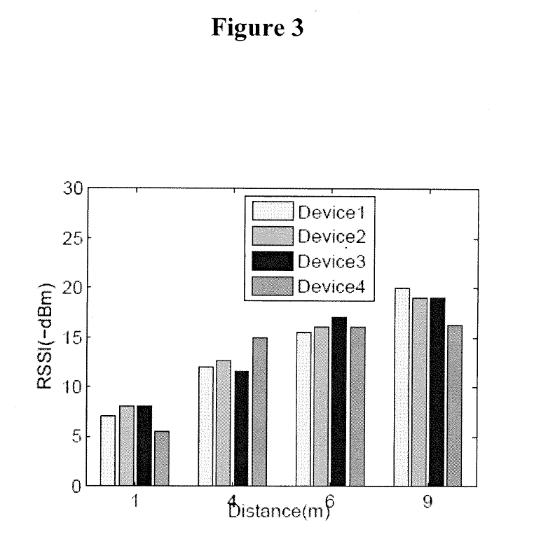

In order to use a communication means such as Bluetooth for communications between the tactile sensor, as well as any other external sensors, and the mobile phone, the phone also has to be able to detect the devices around it based on the signal strength. FIG. 3 shows the relationship between signal strength and distance for four different devices.

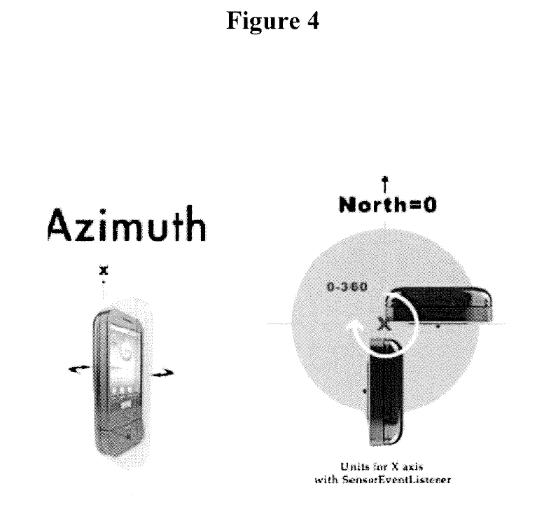

The current embodiments utilize the accelerometer, compass, and magnetometer sensors present in a mobile smartphone. The compass, or orientation sensor, is used for direction information. The X axis refers to the screen's horizontal axis pointing to the right, the Y axis to the screen's vertical axis pointing towards the top of the screen and the Z axis pointing towards the sky when the device is lying on its back on a table. Acceleration is recorded when there is a force exerted on the phone along any of the axes. For the embodiments described herein, the placement of the phone is such that its X axis is parallel to the direction of travel, the Y axis horizontally perpendicular, and the Z axis vertical. FIG. 4 shows additional representations of the orientations, in which X represents the azimuth, which is the angle in reference to magnetic north. The units of measure are between 0 and 360 degrees, which represents a complete rotation divided by 360 equal divisions.

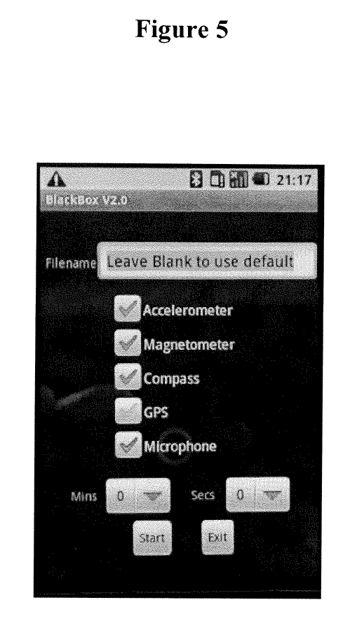

The present indoor navigation system utilizes a mobile smartphone having an appropriate software application program installed. The program should activate the sensors desired for each application and provide application programming interfaces for each. The program will record the data collected as input from the particular sensors, record the time period of measurement, and optionally allow this data to be designated by a particular filename. In one embodiment, the application software can have an interface such as that shown in the screen shot in FIG. 5.

In certain embodiments, the acceleration is recorded using the accelerometer sensor and then filtered using an appropriate signal processing filter to remove unwanted “noise.” such as a Butterworth filter. After this pre-processing, it is fused in the data fusion module. The velocity and distance traveled can then be obtained from the denoised data. The X and Y coordinates are in turn calculated from the obtained distance using a Euclidean distance formula. In this formula, aᵢ, vᵢ, and dᵢ represent the acceleration, velocity and distance traveled at iₜₕ time instant respectively. Δt represents the sampling interval. Approximately 10 samples were recorded for every second. The velocity was computed using the following formula:

$${v}_{i} = {v}_{i - 1} + \frac{( {a}_{i - 1} + {a}_{i} )}{2} Δ t$$

The relative displacement was computed using the following formula:

$${d}_{i} = di - {d}_{i - 1} = {v}_{i} Δ t = {v}_{i - 1} Δ t + \frac{( {a}_{i - 1} + {a}_{i} )}{2} Δ {t}^{2}$$

In certain embodiments, algorithms such as particle filters that are part of the fusion module can be used to determine the estimates of distance traveled and location. Particle filters are probability based approximation algorithms that belong to the family of Sequential Monte Carlo methods. They can be used to produce Bayesian estimates based on data collected. The Bayesian approach is traditionally used for obtaining an optimal solution to a state estimate since it computes the posterior probability density using all the available information including the set of measurements (Arulampalam et al. 2001). However some applications may require an estimate for every time instant. In those cases, recursive filters can be used to process the measurements sequentially as they are obtained at every time instant. This method is advantageous in that the set of measurements need not be stored for computation. The prediction stage involves estimating the state of a system or rather its probability density functions for the next time instant based on the previous measurement. The update stage is where the estimated value is compared with the original measurement that is obtained in the time instant for which the prediction was made.

As explained in Fox et al. 2003, for estimating a quantity, Bayes filters maintain a probability distribution for the quantity estimate at time k referred to as the belief Bel(sₖ). A set of Nₛ particles is used to represent the posterior density or belief given by the equation below.

$$p ( {s}_{k} \vert {Z}_{k} ) \approx {\sum }_{j = 1}^{{N}_{s}} {π}_{k}^{j} λ ( {s}_{k} - {s}_{k}^{j} )$$

In the equation above, each particle with index j has a state s^{j}ₖ and a weight π^{j}ₖ. The sum over all particles weights is one and their respective weight is calculated using the equation below.

$${π}_{k}^{j} ∝ {π}_{k - 1}^{j} \frac{p ( {Z}_{k} \vert {s}_{k}^{j} ) p ( {Z}_{k} \vert {s}_{k - 1}^{j} )}{q ( {s}_{k}^{j} \vert {s}_{k - 1}^{j} , {Z}_{k} )}$$

For multiple sensors, the measurement likelihoods can be multiplied in the weight update process.

πₖ^{j}=πₖ₋₁^{j}p(Zₖ|sₖ^{j})

Various models are useful for the data processing involved in the fusion module and the estimation of location. One is the state model. The state model s^{k} consists of:

$${s}_{k} = [ \begin{matrix}{x}_{k} \\ {y}_{k} \\ {φ}_{k}\end{matrix} ]$$

where xₖ=(xₖ−1)+v an yₖ=(yₖ−1)+v indicate that the present x and y coordinates of the trajectory walked depend upon the coordinates in the previous time instant added by noise v called Process noise, phiₖ=phiₖ₋₁+v indicates the heading in the previous time instant added by noise.

In the measurement model, the set of measurements denoted by Zₖ are obtained from the sensors and represent the state of the system added with noise n_{δ} given by the equation below:

Zₖ=h(sₖ,n_{δ})

In particle filter propagation, the initial set of particles are assumed to be Gaussian distributed around the initial state value. The measurement likelihood is calculated using the Gaussian kernel function as given in the equation below:

$$p ( {Z}_{k} \vert {s}_{k}^{j} ) = \frac{1}{{σ}_{v} \sqrt{2 π}} {e}^{- \frac{{( {z}_{k} - {s}_{k}^{j} )}^{2}}{2 {σ}_{v}^{2}}}$$

To apply the particle filter to the estimation of location coordinates, both the accelerometer and compass measurements should be dealt with. Then the likelihood p(z|x) which is used for the computation of weights is to be obtained and resampling has to be done to resolve the inherent sample impoverishment problem of particle filter. Algorithm 1 runs at every time step t. Step (i) and (ii) update the sensor measurements respectively. According to the probability distribution, namely distribution of weights, at the previous time t−1, step (iii) and (iv) draw one sample from the set of previous samples. Hence, samples with higher weights will be drawn more frequently. Step (v) and (vi) add additional noise to the samples to settle the inherent sample impoverishment problem of the SIR particle filter. Step (vii) updates the weights based on the likelihood of the measurements.

The algorithm below represents a modified particle filter algorithm that could be used with embodiments of the present indoor navigation system.

| 1: | for k = 1:2 do | | |
|---|---|---|---|
| 2: | | (i) Update measurement Accₖ for accelerometer | |
| | | data | |
| 3: | | (ii) Update measurement Comₖ for compass data | |
| 4: | end for | | |
| 5: | for i = 1:N do | | |
| 6: | 1) | | (iii) Draw sample Accₜ₋₁ⁱ where p(Accₜ₋₁ⁱ) = |
| | | | Accₜ₋₁ⁱ, wₜ₋₁_{_{j=1. . .N}}ⁱ) |
| | 2) | | (iv) Draw sample Comₜ₋₁ⁱ where p(Comₜ₋₁ⁱ) = |
| | | | Comₜ₋₁ⁱ, wₜ₋₁_{_{j=1. . .N}}ⁱ) |
| | 3) | | (v) Accₜ₋₁ⁱ = Accₜ₋₁ⁱ + δ |
| | 4) | | (vi) Comₜ₋₁ⁱ = Comₜ₋₁ⁱ + δ |
| | 5) | | (vii) Update weights using πₖ^{j} = |
| | | | πₖ₋₁^{j}p(Accₖ\|sₖ^{j}).p(Comₖ\|sₖ^{j}) |

| 7: | end for | |
|---|---|---|
| 8: | for i = 1:N do | |
| 9: | | (viii) Normalize weight by ${w}_{t}^{i} = \frac{{w}_{t}^{i}}{{Σ}_{i = {1}^{n}} ( {w}_{t}^{j} )}$ |

| | |
|---|---|
| 10: | end for |

### Example 1

### Navigation of Turns

The initial phase of research consisted of understanding the sensitivity of the accelerometer and compass. The correctness in headings recorded by the compass were examined while different turns were taken inside buildings along different corridors. Hence the experiment consisted of the subject walking along different corridors making four turns towards East, West, North and South. The experiment was repeated at 8 different locations. Table 1 below lists the number of locations and measurements obtained at each location.

TABLE 1
Locations and Ambulatory Measurement Count

| Location | # Measurements |
|---|---|
| Faculty corridor | 115 |
| CSE corridor wing 1 | 75 |
| CSE corridor wing 2 | 126 |
| Cafeteria corridor upstairs | 100 |
| Cafeteria corridor downstairs | 80 |
| Electrical Engg corridor | 80 |
| Mechanical Engg corridor | 80 |
| Student lobby area | 80 |

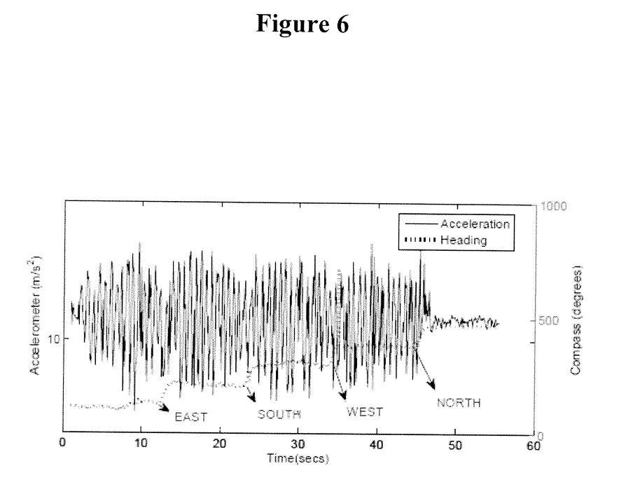

The recorded accelerometer data was used to compute the number of steps walked. FIG. 6 shows the integrated plot of both accelerometer and compass data. The magnitude of accelerometer data was obtained by A²=A²ₓ+A²_{y}+A²_{z}. By counting the number of peaks in the accelerometer data, the number of steps walked before every turn was computed. The plot in FIG. 6 shows four turns taken after 14 steps or 10 m towards E, S, W and N as detected by the compass. The peaks in the plot are the steps detected by the accelerometer.

### Example 2

### Distance Estimation

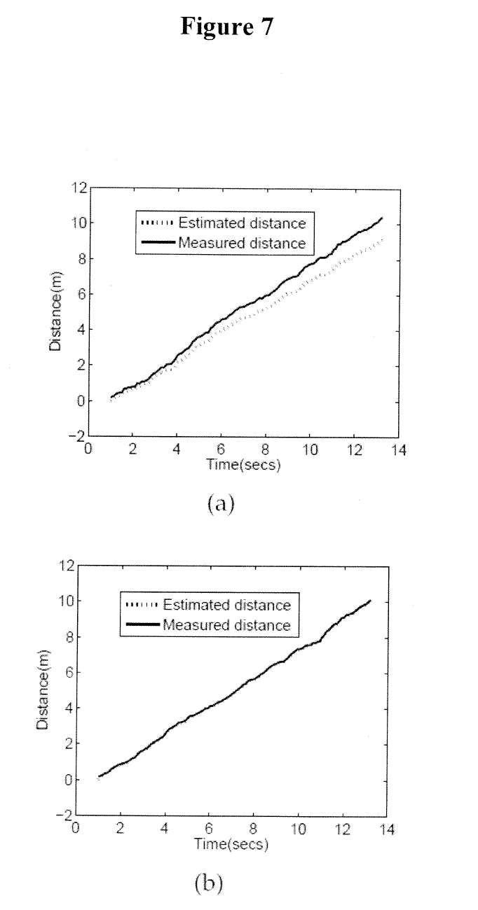

Estimating the distance traveled basically allows computing of the remaining distance to the destination and navigating the person accordingly. The estimation accuracy of the system is a very important factor here. Simple walking experiments for a distance of 11 m (manually measured) were performed. The recorded acceleration was double integrated to obtain the velocity and distance as explained above. The performance of the particle filter was evaluated with fused (accelerometer and compass) and single sensor (accelerometer only) information. A comparison of the measured and estimated distances is shown in FIG. 7. FIG. 7(a) shows the estimated and measured distance without fusion and indicates that the particle filter does estimate the distance quite well with just the computed distance information. FIG. 7(b) shows the estimated and measured distance after fusion of compass data. This indicates that the performance of the particle filter is better in estimating the true distance when fusion is used.

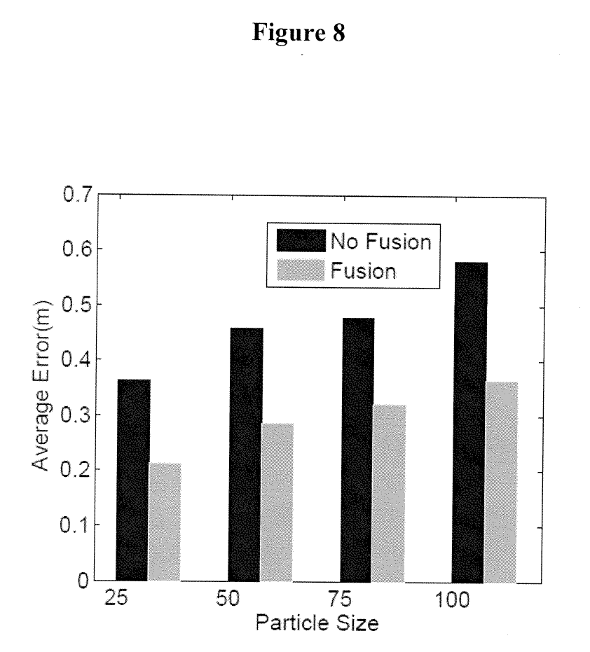

For the distance estimation, the error was computed between the estimated and measured distance. Different particle sizes were used to evaluate the particle filter performance over fused and single sensor information. The average error was calculated for both the fused and non-fused scenarios and is depicted in FIG. 8. FIG. 8 shows that for every particle size, the error obtained from fused information is less than that obtained from the information obtained from a single sensor. This also demonstrates the advantages of using fused data.

### Example 3

### Trajectory Estimation

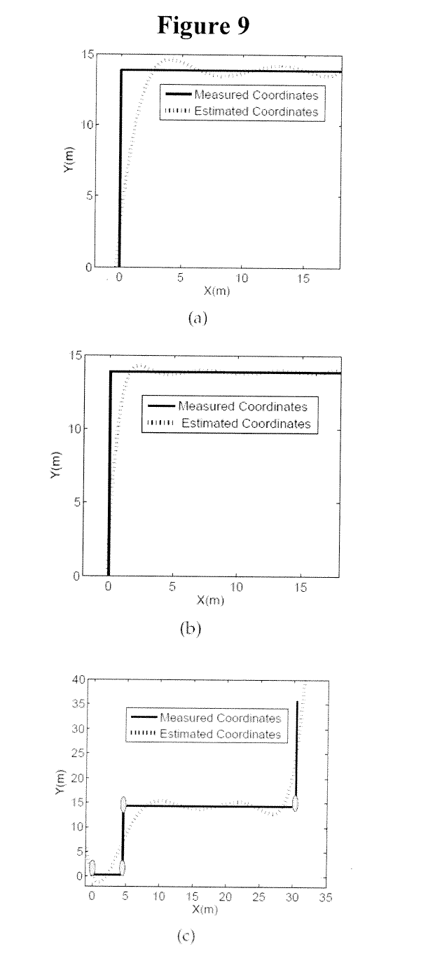

Estimating the trajectory is another important factor in the navigation system. Guiding a person in taking a correct turn requires monitoring the distance walked and also the angle of turn taken. Hence the closest estimation of a turn is very essential. This experiment consisted of making single, two and four turns. For a single turn, the subject walked in a straight line for 14 m, made a right turn and then walked for another 18 m, thereby covering a total distance of 32 m. For four turns the subject walked different distances, but approximately covered a total distance of 35-38 m. FIG. 9 shows the particle filter performance for one and four turns. FIG. 9(a) shows the trajectory estimation without fusion. This plot shows that when heading information is not fused, the filter does not provide a close estimate of the trajectory. FIG. 9(b0 shows the trajectory estimation with fusion. This plot shows that when the heading information is fused in the weight update phase, the filter provides a better estimate of the trajectory. FIG. 9(c) shows the trajectory estimation with fusion for four turns. This shows that the particle filter tracks the turns, which are illustrated with grey ellipses, to a certain extent.

As with estimating distance, estimating the trajectory walked is very essential. The average error between estimated and measured coordinates was computed and the accuracy of the particle filter was obtained. These are tabulated in Table 2 below. The accuracy is low for certain locations and turns. This could be attributed to the magnetic anomalies that cause the compass to fluctuate. In other words, wrong heading values can be recorded by the compass due to magnetic interference. This information when used in the particle filter could result in low trajectory estimation since the particle weights are updated according to the measurements.

TABLE 2
Accuracy of Particle Filter for Turns

| | | # Mea- | Avg- | Accu- |
|---|---|---|---|---|
| # Turns | Location | surements | Error (m) | racy (%) |
| 1 | Network security research | 30 | 0.14 | 86 |
| | lab pathway | | | |
| | CSE corridor wing 1 | 25 | 0.17 | 83 |
| | CSE corridor wing 2 | 26 | 0.18 | 82 |
| | Arts and Science corridor 1 | 34 | 0.15 | 85 |
| | Library Wing 1 | 35 | 0.13 | 87 |
| 2 | CSE corridor wing 2 | 25 | 0.28 | 72 |
| | CSE corridor wing 3 | 35 | 0.22 | 78 |
| | EE to CSE corridor | 28 | 0.27 | 73 |
| | CSE corridor wing 4 | 31 | 0.29 | 81 |
| | CSE corridor wing 5 | 32 | 0.24 | 76 |
| 3 | Deans office lounge | 28 | 0.31 | 79 |
| | CSE corridor wing 2 | 35 | 0.32 | 78 |
| | CSE corridor wing 3 | 28 | 0.37 | 73 |
| | CSE corridor wing 4 | 31 | 0.31 | 83 |
| | CSE corridor wing 5 | 32 | 0.29 | 82 |

### Example 4

### Magnetic Mapping and Landmarking

Magnetic field variations inside buildings are found in iron, cobalt or nickel and also occur from man-made sources such as steel structures, electric power systems and electronic appliances. If these variations or anomalies are identified, they can provide a unique fingerprint or profile for places inside buildings where they exist. For instance, a specific corridor could be characterized by its magnetic field intensity profile or an office can be profiled to help in the future by identifying whose office an individual is presently in. Pillars and other structures that show high magnetic field values along these corridors could very well be identified as landmarks and used as guideposts for navigation. Developing magnetic maps of buildings can educate the general public, employees, and even maintenance workers about the levels of magnetic flux in the surroundings. Once understood, these maps can help in the development of a building by providing a set structure or layout. The number of landmarks and their separating distances can then be implemented throughout the building to provide an easy analysis when integrating the building with indoor navigation.

Magnetic fields in general are caused by electrical installations, appliances and heavy duty machinery. There are two different types of magnetic fields, namely static and dynamic. Dynamic magnetic fields are those that fluctuate dynamically from an electrical device such as a CRT or LCD screen. Static fields, which are generally larger, are seen in big machinery devices such as used in constructing materials or medical applications like MRI or X-ray machines. The IEEE Standard C95.6 prescribes the maximum permissible exposure (“MPE”) levels for a magnetic field or magnetic flux density. The MPE is expressed as a function of frequency of the field and the limit is more restrictive for one's head than for the rest of the body. Since the brain is where most of the electrical impulses and functions are gathered and processed, limited head exposure to massive static magnetic field impulses is critical. For the head, the MPE for magnetic flux density is 353 mT at DC and 680 μT at 3 kHz. Since most of our appliances and devices operate somewhere around the 60 Hz range, a limited exposure to magnetic field should fall somewhere below the MPE standards. For reference, the average magnetic field induced by the earth in North America is about 50 μT.

Utilizing the magnetic field information inside buildings for navigation purposes has not been exploited in the design of an indoor navigation system for humans. However, landmarks inside buildings provide valuable information for indoor navigation. For instance, identifying a particular pillar or elevator along a corridor could make it easier to reach the intended destination that is near or around these landmarks. A mobile smartphone equipped with a 3-axis magnetometer can be used to measure and calculate the magnitude of the magnetic fields inside the building.

Experiments were performed along selected building corridors, with y-axis parallel to the North. The experiments were repeated multiple times to check the reliability of the readings. In the first experiment the magnetic field strengths were collected by standing near each pillar for a duration of 15 seconds. In the second experiment, an individual walked past each pillar along the 200 m corridor to collect the variations at and in between each pillar. The data from the two experiments was analyzed to check for consistency of readings. Table 3 below lists the number of pillars at different corridors and the number of measurements taken at those corridors. From the table it is clear that an exhaustive set of readings were collected. For each pillar, the magnetic field strength was recorded approximately 10 times.

TABLE 3
Data collection

| Corridor | # Pillars | # Measurements |
|---|---|---|
| CSE corridor wing 2 | 16 | 176 |
| Electrical Engg corridor | 18 | 75 |
| Cafeteria corridor upstairs | 16 | 128 |
| Cafeteria corridor downstairs | 17 | 85 |

Table 4 below lists the measurement error and the confidence intervals of the magnetic field intensity for 7 pillars along a corridor. By employing simple statistical techniques, the reliability of the data collected over multiple experiments was evaluated.

TABLE 4
Reliability testing

| Pillar Num | Std Error (%) | 90% Confidence intervals (microT) |
|---|---|---|
| 1 | 6.7 | 182.26 < 183.92 < 185.59 |
| 2 | 2.2 | 21.12 < 21.5 < 21.90 |
| 3 | 1.2 | 49.77 < 50.31 < 50.86 |
| 4 | 1.4 | 39.91 < 40.29 < 40.66 |
| 5 | 2.3 | 71.17 < 71.88 < 72.60 |
| 6 | 1.1 | 32.19 < 32.62 < 33.05 |
| 7 | 2.8 | 39.48 < 39.91 < 40.33 |

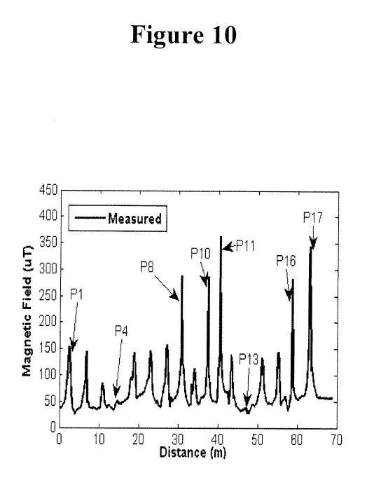

From Table 4, it can be seen that the error is not very high, demonstrating the reliability of the sensor. There is also not much variation between the data in each experiment. This simple test allows for a clear understanding of the sensor characteristics. The 16 pillars located in CSE corridor wing 2 were uniquely identified by the magnitudes of the magnetic field strength at each pillar. The pillars located in the cafeteria corridor upstairs were similarly identified based on different magnetic field magnitudes. FIG. 10 shows a plot of variations in magnetic field while an individual walks past each pillar from one end of a corridor to another. Certain pillars are marked. Table 5 below lists sixteen pillars (P1-P16) found in one example corridor and provides the magnetic field intensities for each one. As Table 5 shows, the different pillars have differing intensities.

TABLE 5
Pillars and Magnetic Intensities

| Pillar | P1 | P2 | P3 | P4 | P5 | P6 | P7 | P8 |
|---|---|---|---|---|---|---|---|---|
| Magnetic | 60 | 150 | 56 | 50 | 45 | 52 | 22 | 28 |
| Field (μT) | | | | | | | | |
| Pillar | P9 | P10 | P11 | P12 | P13 | P14 | P15 | P16 |
| Magnetic | 31 | 65 | 101 | 50 | 45 | 35 | 50 | 120 |
| Field (μT) | | | | | | | | |

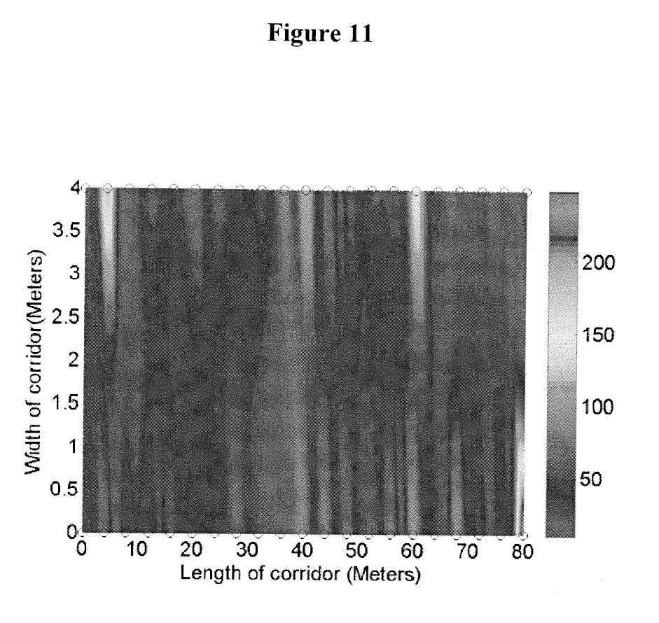

After characterizing pillars with their unique magnitudes and identifying them as landmarks, a map of that uniqueness can be developed in the form of a magnetic map such as that one shown in FIG. 11. In FIG. 11, the magnetic field strength intensity is shown for pillars, which are marked by circles, on each side of the example corridor. This information when integrated with a building map can give information about the magnetic flux around various locations and features within the building.

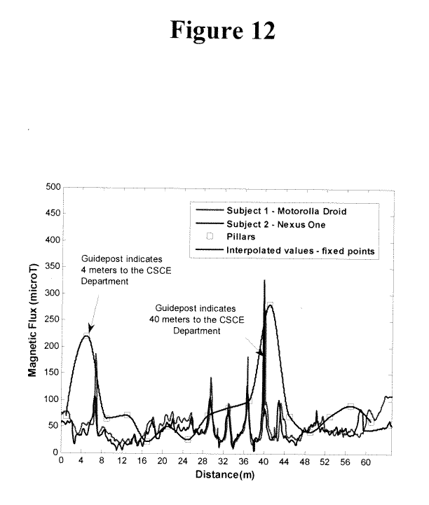

Guideposts are specific points of interest that can be used for fine navigation. For example, at any point in time and space within a building, a certain pillar number could be recognized as a certain distance from a present location or as the pillar next to a particular location and so on. If the distance between each pillar is known, these guideposts can be quantified. In all the experimental corridors, the pillars were equally spaced approximately 4 m apart. So by using this information, a pillar that has been landmarked can be identified. FIG. 12 explains this concept. In FIG. 12, the first peak indicates a pillar that is 4 m away from a particular location, in this case the CSCE department. The next peak or pillar is found at a distance of 40 m away. With each pillar uniformly spaced at every 4 m, the distance to reach a destination can be calculated.

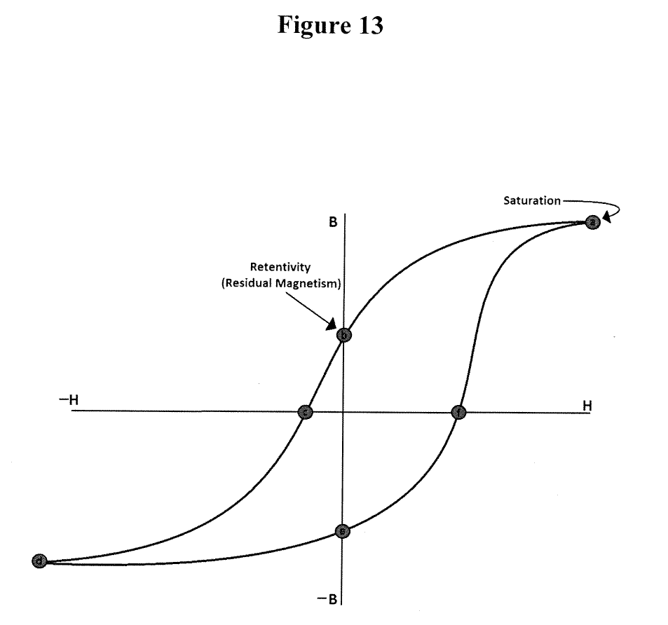

FIG. 13 is a map showing the magnetic field intensities of pillars present on both sides of a corridor. The arrows show the direction of the magnetic field, indicating that the field around the pillars points towards the north.

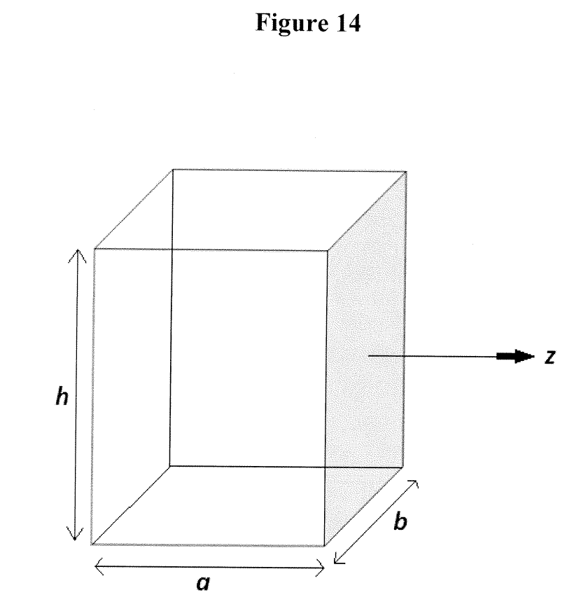

Without wanting to be bound by theory, the variation in the magnetic field near pillars can be attributed to the density of ferromagnetic material that makes up each pillar. Hence it will likely be an arduous task to exactly model these variations. The ferromagnetic pillars used in this example are categorized as a steel substance. Understanding how these materials interact when induced by an external magnetic field and then maintaining that field through retention is difficult to model precisely without an exact analysis of the magnetic moment and volume of the material at an atomic level. For this example, a function was used that is based on residual magnetism, the dimensions of the material and the distance at which it is being measured. This function is used by many magnet and magnetic sensor manufacturers, including those that manufacture magnetometers for use in mobile smartphones. This function is used in many simulation techniques and is suitable for use as a model of the ferromagnetic material present in the pillars. The retentivity of the material is the point at which some magnetic field remains in the material after the magnetizing force has been removed. The ability to retain such a force is the basis of ferromagnetism. This point is below maximum saturation and can be seen in the hysteresis loop shown in FIG. 14 as Point b or the Residual Magnetism (Br).

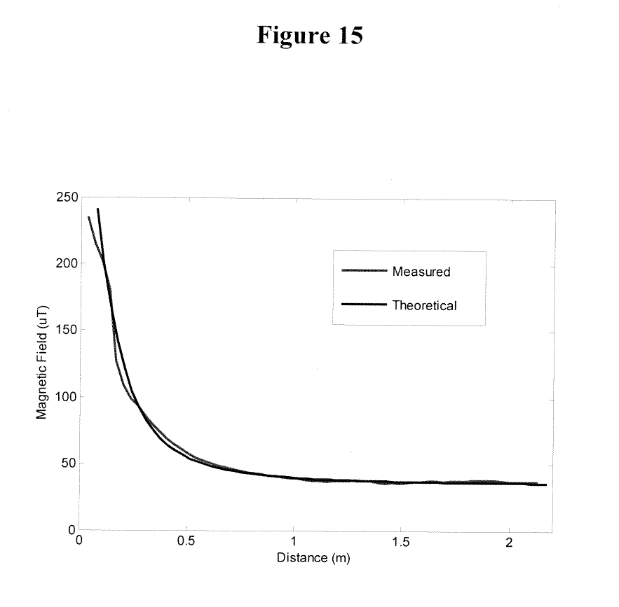

In FIG. 14, B represents the magnetic flux density while H signifies the magnetizing force. The point at which the magnetic force is zero while still resulting in a positive magnetic flux is called the residual magnetism, represented by point b. The saturation point, or point a, represents the alignment of all atoms in the material. This is also known as the highest magnetization point. In FIG. 14, at saturation (Point a), the magnetic force (H) along with the magnetization of the material contribute to the total magnetic field of the ferromagnetic material. Since no external field is present, an equation is used that is based on simulations that are used in comparison to the measured data taken by the mobile smartphones. See McCaig et al. 1987 and Oldenburg et al. 1998. FIG. 15 shows a diagram of the equation that represents a structured pillar and its dimensions having the following variables: Length (a), width (b), height (h) and the distance at which the field is measured (z).

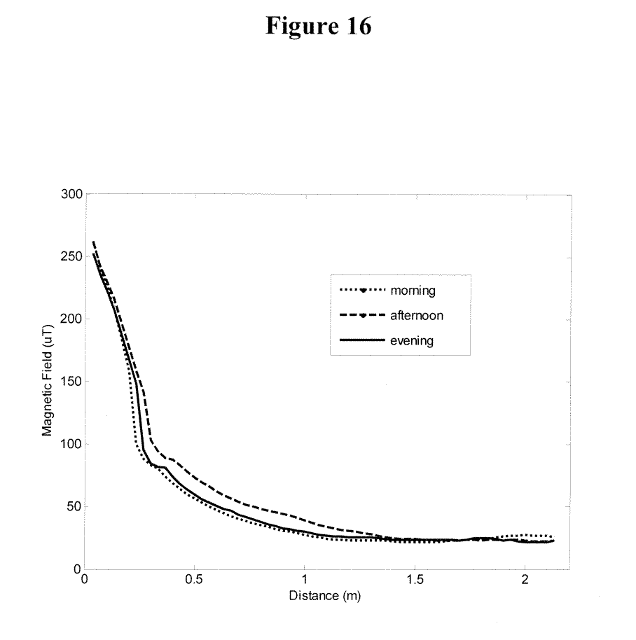

The equation in FIG. 15 is useful for modeling magnetic intensity distributions with respect to distance, which is what is needed for comparison with the tested pillars. The length, width, height, residual magnetic field at the surface, and distance from the magnetic surface are all taken into account to calculate the approximate magnetic field along the material's surface. The residual magnetic field is dependent on the material in question and because it is not affected by the shape of the material, is often used in simulation. FIG. 16 is a graphical representation comparing the measured magnetic field distribution of a pillar and the theoretical data using the equation. The dimensions of each pillar are approximately 20 cm by 20 cm by 500 cm and were measured at a constant distance from an initial 2.5 cm from the pillar to a distance 213 cm away from the pillar. The plot in FIG. 16 shows a similar distribution over 2 m, which demonstrates that the equation is an acceptable theoretical model for the magnetic field distribution.

As an example, steel has a high retentivity so the material produces a magnetic field without an external source present. This permanent field makes it useful for creating magnetic maps for indoor navigation using mobile smartphones as measurement devices, as steel is present throughout a majority of modern buildings.

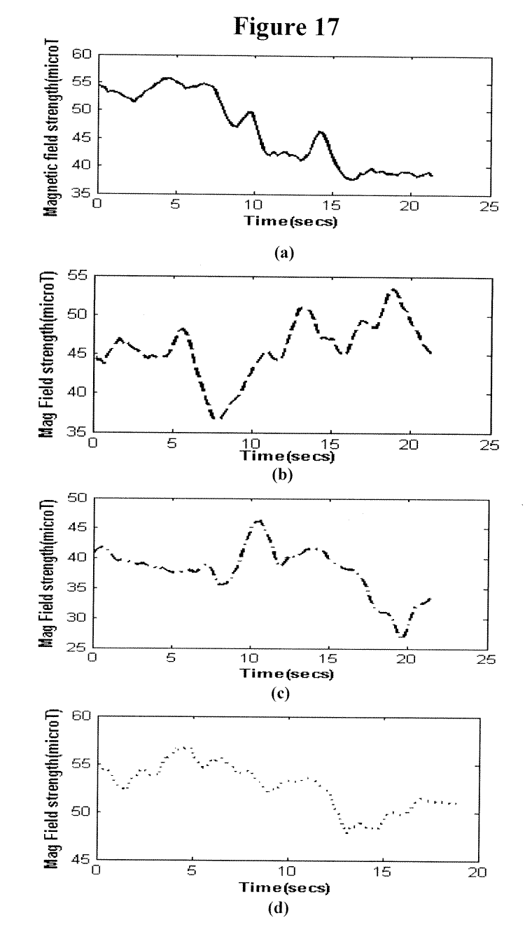

The measured magnetic field distribution of all the pillars measured follows the same path relative to its initial strength, which is dependent on the material's atomic magnetic moment density, which is theoretically different for each individual pillar. Thus, each pillar is independent from one another as they produce different intensity levels. Surface distribution is not uniform as large distances along a pillar's surface were measured and demonstrated a change in field strengths. However, field strengths remain constant where measured and this separating distance needs to be greater than 1 m to see a significant change in intensity. The pillars were tested to obtain a consistency in field strength at different times of the day. FIG. 17 illustrates the data obtained for the magnetic field distributions for different times of the day. The variation is similar over any time period throughout the day, indicating a constant field throughout the day. Consistency in measurements is significant as it is a requirement in the classification of a pillar as a landmark.

Many of the observations reported and analyzed applied to distance. The magnetic field was affected to about 1 m from the pillar before leveling out. Since each pillar is uniformly 4 m apart, the magnetic field of one pillar does not affect another adjacent pillar. In addition, the beams from the ceiling also have no affect on the pillars as the measurements were recorded about 3 m below the ceiling. To be affected by an external magnetic field, an object has to be within 1 m of the pillar. As this was not the case in any of the experiments, the measurements taken were not affected by any auxiliary fields due to the ferromagnetic material of the pillars.

The data sets recorded were taken throughout the building which contains a first floor and a second floor. The magnetic field produced by a pillar on the first floor is independent of that of the same pillar on the second floor as they tend to emit varying intensity levels. This can be due to the density of iron atoms throughout the material as it is more magnetized around one area of the pillar than another. This density characteristic helps with localization as the absence of a relationship between floor pillars actually aids to differentiate which floor an individual is on.

Not only are there numerous pillars throughout a measured complex, but there are also many different types of pillars. Each type of pillar has a different dimension that helps to aid in the maximum magnitude and the magnetic field distribution, shown in Table 6 below. It is significant to note that the certain types of pillars are likely to be found in certain locations. Very high magnetic field producing solid pillars were observed to be positioned around corners of each corridor, H-Shaped pillars were stationed around office and lab areas, and small solid pillars were located around restroom facilities. The location of each type of pillar can help locate which part of the building an individual is in as the intensity and distribution for each type of pillar are different. Table 6 shows a relationship between high field strength and corner type pillars, which helps to indicate that an individual has reached a new corridor. A pair of solid pillars also results in a higher total magnetic field strength recorded, as each contributes to the total value. Solid middle, solid small, and H-shape pillars have similar strengths that would likely need to be used in series to assist in locating a specific location.

TABLE 6
Pillar Dimensions and Field Strengths

| | Physical Dimensions | |
|---|---|---|
| Type of Pillar | a × b × h (cm) | Typical Strength (μT) |
| Solid (corner) | 20 × 20 × 500 | 150-500 |
| Solid (middle) | 20 × 20 × 500 | 20-280 |
| Solid (pair) | 20 × 20 × 500 * 2 | 80-320 |
| | (air gap 21) | |
| H-Shape | 10 × 11 × 500 | 30-200 |
| Solid (small) | 15 × 15 × 500 | 25-85 |

Different rooms, corridors, or other areas were also observed to have different levels of magnetic flux that can be considered as a unique signature of that area. Not all locations have steel pillars, computers or servers running all day, whereas certain rooms such as research laboratories may have round the clock functioning of computers and other electrical equipment. Magnetic field intensity is expected to be high in rooms such as these, for example, in laboratories compared to classrooms. Measurements were collected from four example research laboratories to determine whether different rooms could be identified or differentiated by their unique magnetic signature.

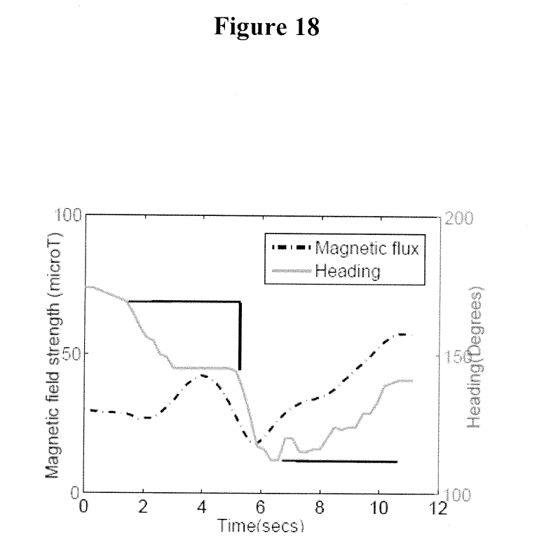

Data collection involved walking along the perimeter of the rooms for a certain time period. The experiments were repeated to obtain reliable data. FIG. 18 shows the profiles of magnetic field data collected for the four tested research laboratories (a)-(d). In FIG. 18(a), the tested laboratory had 16 PCs, two servers, a microwave, refrigerator, and other electrical equipment. In FIG. 18(b), the laboratory had 10 PCs and a microwave. In FIG. 18(c), the laboratory had 4 PCs. In FIG. 18(d), the laboratory had 5 PCs and a microwave. The similarity of these signatures was calculated using a correlation coefficient, with the results shown in Table 7 below. Since each room had a different profile, the correlation between them was demonstrated as weak. However, there is a very high correlation between the same locations.

TABLE 7
Correlation of Coefficients

| Laboratory | F238 | F237 | F236 | B219 |
|---|---|---|---|---|
| F238 | 1 | −0.54 | 0.58 | 0.06 |
| F237 | −0.54 | 1 | −0.49 | −0.15 |
| F236 | 0.58 | −0.49 | 1 | 0.01 |
| B219 | 0.06 | −0.15 | −0.01 | 1 |

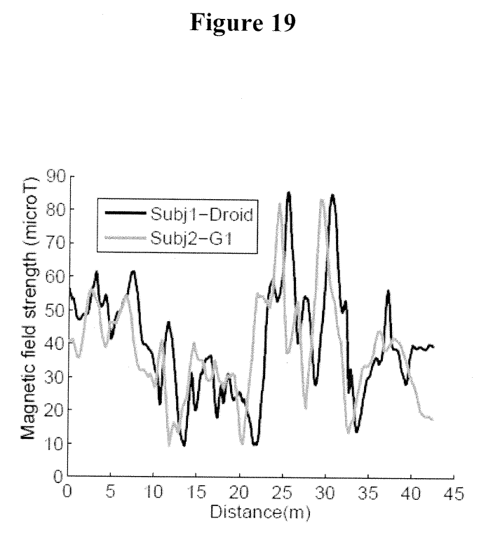

It is also important to note that, with regard to mapping magnetic fields for use in indoor navigation, magnetic anomalies have a tendency to affect the compass in the phone in such a way that the there is a sudden rise or drop in the magnetic flux resulting in sudden change in the direction pointed by the compass. At some spots along corridors this fluctuation can be identified in the compass. For example, even though the phone was pointed towards the South, the compass showed it as North. Once the phone was moved from that point, the compass realigned itself pointing to the correct North. FIG. 19 depicts a case of magnetic anomaly identified along a corridor. As can be seen in FIG. 19, the compass data starts at a value of 200 degrees, which is the direction walked by the individual, but instead of maintaining that value (shown by the straight black lines), it drops down to around 140 degrees at a certain time instant. The same anomaly occurs again at a second time instant. The plot of the magnetic flux shows an increase in the magnetic field strength that is likely responsible for the anomaly.

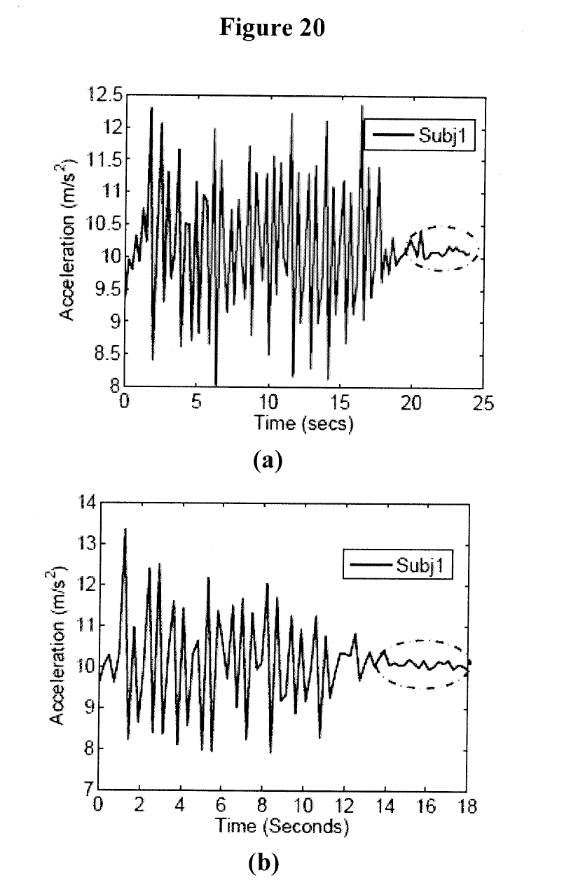

To test the similarities of sensor readings from the magnetometers of two different mobile smartphones, the two phones were used for recording measurements along the same corridor. FIG. 20 shows the magnetic field strength variations recorded using both phones. Even though the magnitudes of the magnetic fields appear different, the patterns of the variations are very similar. The delay is due to the differences in walking speeds of the subjects.

### Example 5

### Navigation Assessment

Wayfinding is a term used to refer to the cognitive and behavioral ability of a person to find his way from an origin to a destination. This can be based on information such as landmarks, heading or direction, turns to be taken and the like. Loomis et al. (1993) provide a comprehensive discussion of nonvisual navigation by the blind and sighted. They observed that blindfolded people tended to either underestimate or overestimate the distance to reach a target or the angle to make a turn. Overestimation is walking more than the required distance and underestimation is the opposite of that. Veering is the departure from linearity when travelling. In other words it means the tendency to sway from a center line when visibility is occluded. Also when blindfolded, sighted people tend to walk at a slower pace due to reduction in confidence levels about the spatial environment around them. Fear of bumping into walls, pillars and the like could be factors contributing to this speed reduction.

The present indoor navigation system should ideally be designed with these tendencies in mind. It is important therefore to consider how frequently individuals need to be alerted with navigation instructions before reaching a destination. It is also important to consider what the optimal turn is in degrees and the average speed required to walk certain distances.

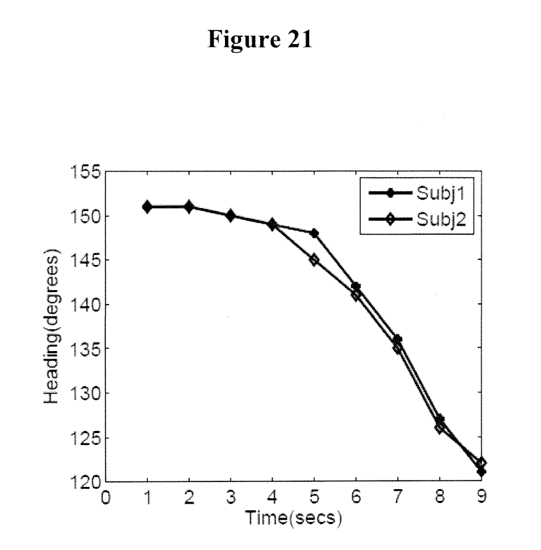

Using five blindfolded, sighted people, two types of experiments were performed. In Experiment 1, sighted subjects first walked in a straight line for distances of 2 m, 4 m, 8 m, 12 m and 16 m to reach a particular destination along a corridor they had no prior knowledge about. By performing trials, the time duration for each of the distances was set to 3, 6, 12, 18 and 24 seconds, respectively. Then each of them was blindfolded and asked to repeat the experiment. The sensor readings were recorded for both experiments. The experiments were repeated 3 times for each subject. FIG. 21 shows the accelerometer data obtained from a subject for distances of 12 m and 16 m. In FIG. 21(a), minor variations, emphasized with the dotted line ellipse, in the accelerometer data from the 16^{th} to 24^{th} time instants indicate that the subject stopped before reaching the destination, underestimating the destination by 8 m. For 12 m, in FIG. 21(b), the same phenomenon is observed from the 12^{th} to the 18^{th} time instants, again shown by the dotted line ellipse, indicating an underestimation of 4 m.

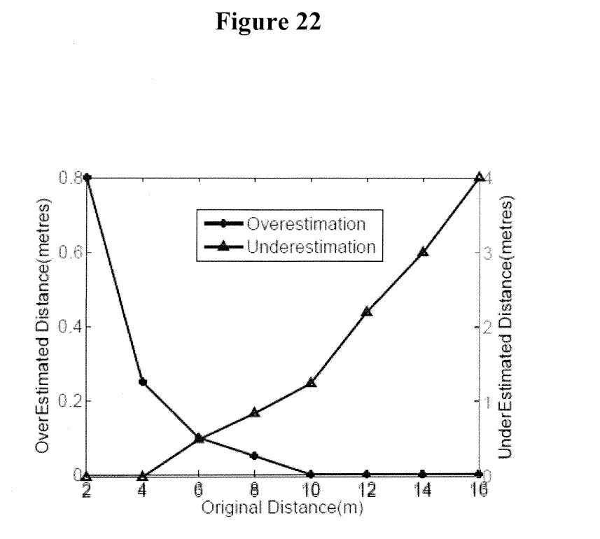

In Experiment 2, sighted subjects first walked in a straight line for distances of 4 m, 8 m and 12 m and 16 m and then made a 90 degree right turn before stopping. The experiment was repeated after blindfolding. The differences in the heading while making a turn were computed from the compass data and the trajectories of two subjects are shown in FIG. 22. The actual turn to be taken was 90 degrees toward the east, but FIG. 22 shows that the subjects turned about 122 and 124 degrees.

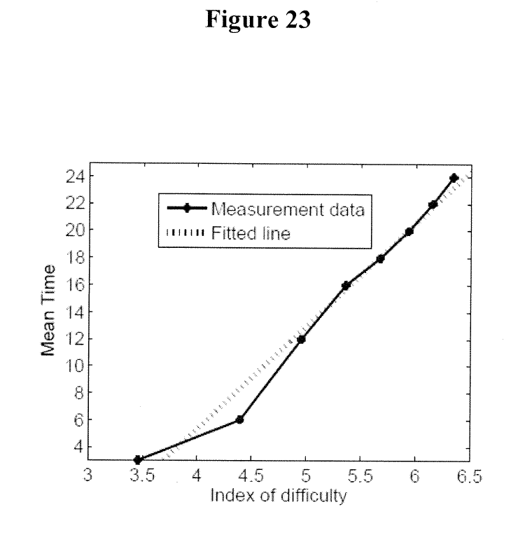

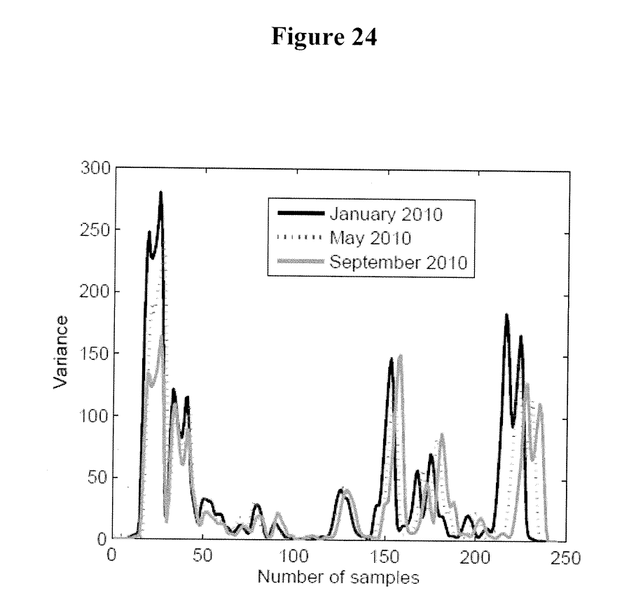

FIG. 23 depicts the relationship of underestimation and overestimation with the distance. As can be seen there is a direct and inverse relationship respectively. From FIG. 23, it can be seen that around 4-6 m, the amount of under or over estimation seems low. Below this distance, overestimation occurs and beyond this distance, underestimation increased gradually. This information could be used in the navigation system to more efficiently alert the individual about the distance remaining to reach a destination.

The experiments indicate that on average a subject overestimated around 0.8 m for a 2 m path and 0.25 m for a 4 m path. A particular subject had average underestimation values of 1.2 m, 4 m and 4 m for 8 m, 12 m and 16 m paths. The underestimation and overestimation distances for all subjects are tabulated in Table 8 below.

TABLE 8
Under and Over Estimated Distances

| | Over Estimation | | Under Estimation | | | | |
|---|---|---|---|---|---|---|---|
| | 2 | 4 | 2 | 4 | 8 | 12 | 16 |
| Subj. 1 | 0.8 | 0.25 | 0 | 0 | 0.5 | 1.25 | 2.5 |
| Subj. 2 | 0.75 | 0.9 | 0 | 0 | 0.9 | 1.9 | 1.75 |
| Subj. 3 | 0.6 | 0.25 | 0 | 0 | 0.25 | 1.1 | 1.25 |
| Subj. 4 | 1.0 | 1.1 | 0 | 0.2 | 1.2 | 4.0 | 1.0 |
| Subj. 5 | 1.0 | 0.5 | 0 | 0 | 0.85 | 2.25 | 3.25 |

Table 9 below shows the angle of turn differences obtained from different blindfolded subjects. The farther the person had to walk, the greater the angle of turn differed from the actual turn to be made. In the experiment, the subjects had to make a 90 degree turn to their left. Making an accurate turn is very important while walking along corridors since most of the corridors are constructed with 90 degree turns rather than curved turns. It is also important to find the right distance to alert a person about the turn. From the straight line walking experiments, it can be deduced that approximately 4-6 m seems to be the optimal distance to notify a person.

TABLE 9
Turn Errors

| Distance | Subj. 1 | Subj. 2 | Subj. 3 | Subj. 4 | Subj. 5 |
|---|---|---|---|---|---|
| 2 | 5 | 3 | 5 | 4 | 2 |
| 4 | 6 | 9 | 8 | 7 | 10 |
| 6 | 9 | 4 | 11 | 8 | 6 |
| 8 | 10 | 9 | 8 | 9 | 8 |
| 12 | 12 | 10 | 11 | 13 | 15 |
| 16 | 25 | 29 | 22 | 23 | 19 |

### Example 6

### Use of Fitt's Law

Fitt's law (see Fitts 1992) is a formal relationship that models speed/accuracy tradeoffs in rapid, aimed movements. According to this law, the time to move and point to a target of width W at a distance D is a logarithmic function of the spatial relative error (D/W) given by the equation below.

MT=α+blog₂(2D/W+c)

In this equation, MT is the movement time, a and b are constants determined empirically, c is a constant with values of either 0, 0.5, or 1, D is the distance (or amplitude) of movement from start to target center, and W is the width of the target. The term log₂(2D/W+ c) is called the index of difficulty (ID) which describes the difficulty of the motor tasks. 1/b is also called the index of performance (IP) that measures the information capacity of the human motor system. Hence the law mathematically quantifies the accuracy of the motor system in carrying out rapid movements to a specific spatial region.

Redefining Fitt's law to the current application, the time required to reach a target destination while blindfolded increases with the task difficulty. The distance is the distance to be traveled and the width is the width of the target point, a square area on the floor measuring 2 feet. The distance, as explained in Example 5 above, ranges from 2 to 16 m. Due to its wide applicability, the measurement data collected was tested in the Fitt's model to determine its usability in the current application. Particularly, Fitt's model was validated to the underestimation curve shown in FIG. 23, since it shows an exponential increase. FIG. 17 shows the linear fitting of the measurement data and how the Fitt's model can be applied to the underestimation measurements of a particular subject.

### Example 7

### Challenges for Indoor Localization

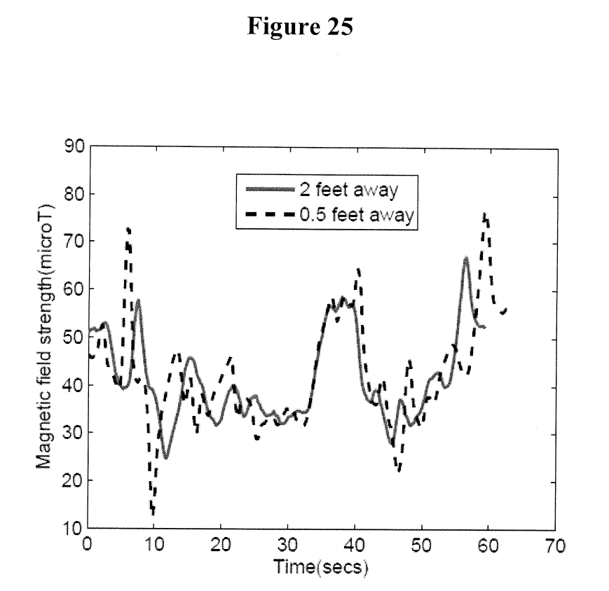

Long term variation: It is the change in the magnetic fields over a certain period of time. To observe this phenomenon, the variance of the magnetic field data was collected over a year. FIG. 25 depicts this as the variance of magnetic signature of a same hallway collected at different months. As can be seen, there is no major variation in all the signatures that could render it ineffective.

Sensor Accuracy: Measurement uncertainty treatment of multiple data sets was collected at each hallway. Measurement uncertainty is a statistical test to find the range of values for the variation of a measured quantity. Summarizing the results, for one hallway, the maximum and minimum values of the magnitude ranged between 110 micro T and 22 micro T, where T stands for Tesla. Hence, the variation was not large enough to affect the signature.

Demagnetization: Some preliminary experiments using permanent magnets explored the temperature at which demagnetization of iron and other ferrous materials occurs, A total of 16% loss in magnetization of the magnet at 110 C was obtained after 30 years. Similarly, after 30 years, a constant temperature of 80 C produced only less than 1% loss in magnetization. Correlating this to the pillars indoors and the environment where the present system will be applicable, at room temperature or even a maximum temperature sustainable by a person, the percent loss produced by the demagnetization process would yield a time that would most likely outlast the average life of most buildings.

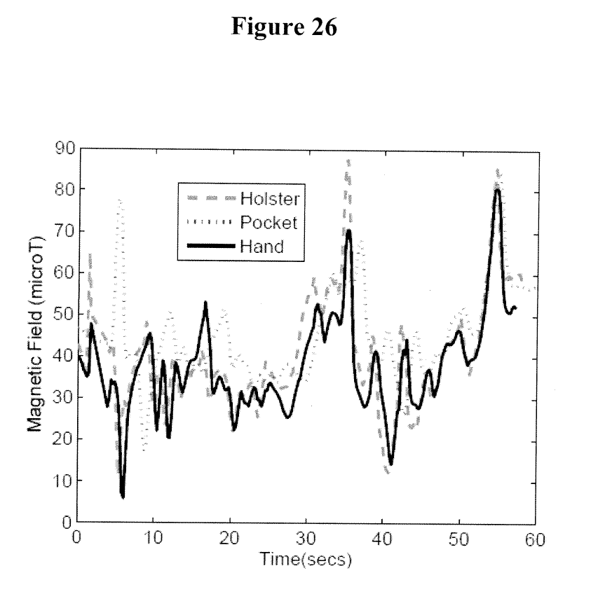

Effect of distance on signature: Magnetic fields are known to be inversely proportional to the square of the distance. Hence the farther the distance from an object, the lower the magnitude of magnetic field. To observe this phenomenon, different distances were walked from walls and pillars. From the measurements it was found that although the magnitude decreased, the signature still held a similar pattern. FIG. 26 illustrates this observation. It can be seen that for the data 2 feet away, the magnitude is reduced as compared to that from 0.5 feet away but the patterns are still similar.

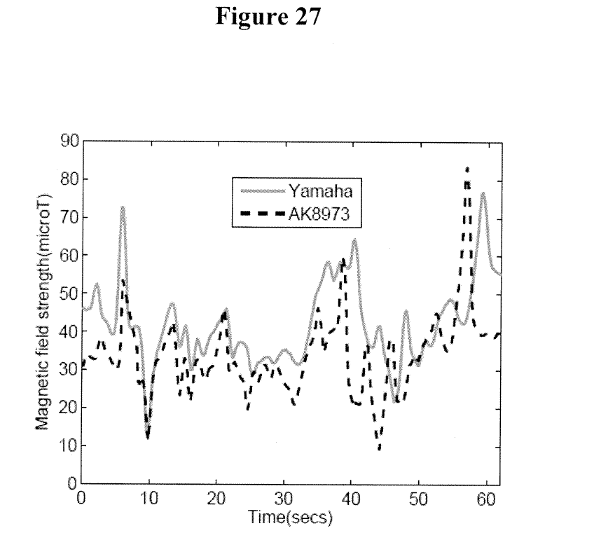

Device placement: Since only the magnitude of the magnetic field is considered, the placement of the phone should not cause any problems in this work. To verify this, data was collected with the phone at different locations: holding in the hand, placed in pocket and fit in a holster. FIG. 27 illustrates the findings.

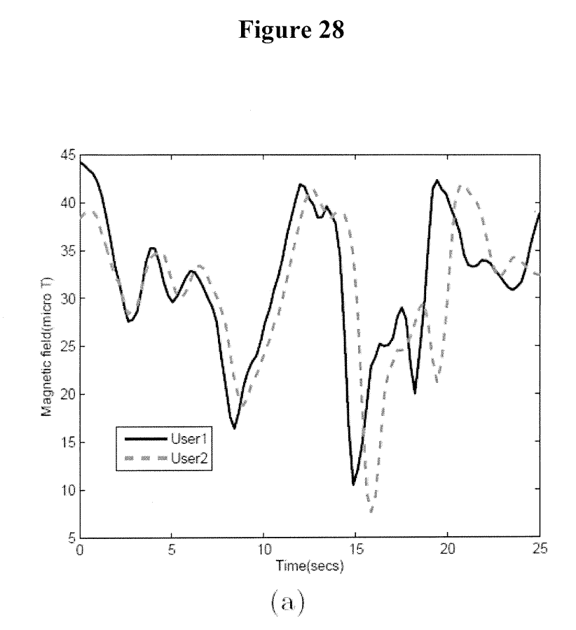

Built-in sensor variation: A Samsung Captivate smart phone was used with a built-in Yamaha magnetic field sensor different from Nexus One. FIG. 28 shows the signature of CSE hallway recorded using the two phones. The signatures are similar from both the Nexus One and Samsung Captivate. This shows the measurement procedure is independent of devices.

### Example 8

### Use of DTW Algorithm for Indoor Localization

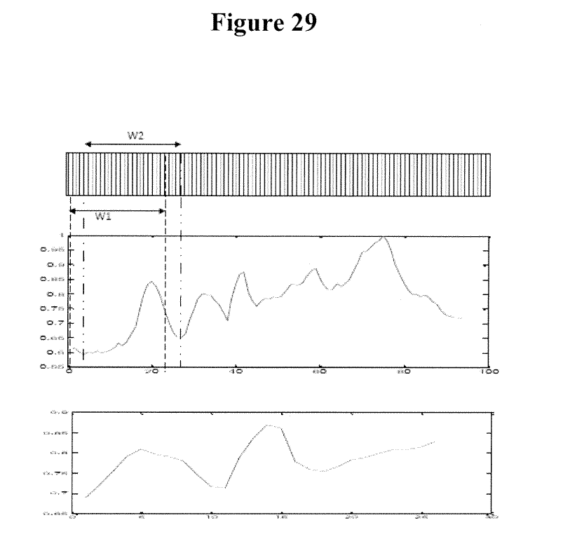

Magnetic signatures collected can be categorized as time series data, that is data collected at discrete time intervals. Walking speeds of people differ due to their walking patterns, physical abilities (blind or visually impaired, handicapped), age and other factors. An indoor localization application should be usable for a variety of people. So when these people walk or traverse along a hallway, the signatures collected may have a similar pattern but vary in time or magnitude as shown in FIG. 29. FIG. 29 shows signature variation along the time and magnitude axis (a). Speed variations cause a shift in the signature collected from Subject 2.

Hence to match these signatures, an algorithm that can perform some form of alignment is in need. DTW is a well known technique for aligning two time series sequences of similar patterns but with deviations in the x or y axes. It has its applications in speech processing, sensor data classification, and data mining to name a few. The advantages of DTW for time series classification and some misconceptions surrounding DTW have been clearly explained (Kneogh et al.).

The technique behind DTW is to compress or stretch the time axis of one (or both) sequences to achieve a better alignment. In general, consider two signatures, T={t₁, t₂, . . . , t_{A}} and S={s₁, s₂, . . . , s_{B}} of different lengths. The goal is to find the best match between the two signatures by some alignment w, the optimal warping path. The warping path is given by w=w(1), w(2), . . . , w(n), where wₙ=[i(n), j(n)] is the set of matched samples, where i and j correspond to the time axes of two sequences respectively. The objective of the warping function is to minimize the overall cost function given by

$$\begin{matrix}D = {\sum }_{n = 1}^{N} δ ( w ( n ) ) \\ where & ( 1 ) \\ δ ( w ( n ) ) = {( i ( n ) - j ( n ) )}^{2} & ( 2 )\end{matrix}$$

The warping path must satisfy the following constraints:

Monotonicity: The warping path must progress in the forward direction, i.e i(n)≧i(n−1) and j(n)≧j(n−1), where w(n−1)=[i(n−1),j(n−1)] and w(n)=[i(n), j(n)].

Boundary: The function must always start at w(1)=(1, 1) and end at w(n)=(A,B).
The function must not skip any points, i.e i(n)−i(n−1)≦1 and j(n)−j(n−1)≦1.

To generate a warping path, a cost matrix is constructed. This matrix represents the minimum cost required to reach a particular point (i, j) from (1, 1). This minimization problem is usually solved using the dynamic programming approach, whereby a cumulative or accumulated distance γ(i, j) is computed as the sum of δ(w(n)), the distance obtained from the current set of points and the minimum of the cumulative distances of the adjacent elements or neighbors. This is given by

(p,q)=δ(w(n))+min[γ(p−1,q),γ(p−1,q−1),γ(p,q−1)] (3)

After performing the time warping, the closest match is obtained by the lowest cumulative distance between the signatures.

### Example 9

### Estimating Localization Distance Using Slidingwindowed DTW

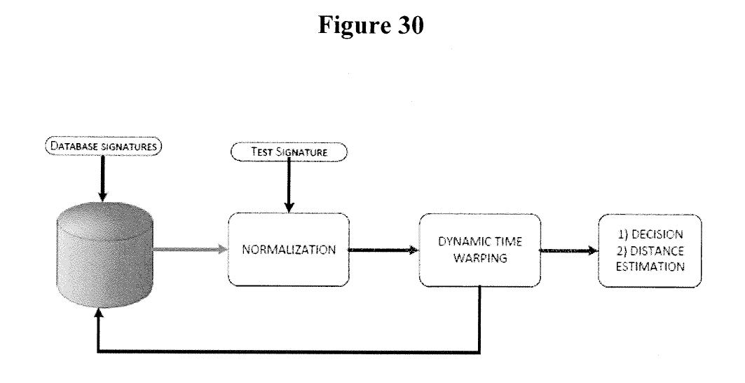

Instead of classifying the test signature of an entire hallway, it was resorted to performing a classification mechanism that reflects a typical scenario where a person walks in a hallway for a distance of a few meters and wishes to know his/her location. In other words, DTW was performed between a short test signature and stored signatures. (Throughout this disclosure, stored signatures may be referred to as maps). To compare a short signature, a sliding windowed DTW was followed. FIG. 30 explains the sliding windowed DTW. A test signature (below) and map (above) are denoted by Tₑ={te₁, te₂, . . . , teₙ}, and M={m₁, m₂, . . . , mₘ}, respectively. Using a sliding window on M, Tₑ is compared with segments of the map, {Mₐ . . . Mₘ}, {Mₐ₊₁ . . . Mₘ₊₁} corresponding to W1 and W2, of width equal to Wₗ, the window length in samples. This process is repeated for all the maps sequentially and the closest match is obtained based on the decision module.

The program picked 100 random positions from each test signature and performed classification for each of those positions. This was mimicking the procedure of obtaining a signature when a person walks for a short distance. The randomly picked segments were of length equal to Wₗ which ranged between 5 and 35. In layman's terms, Wₗ is nothing but the resolution or shortest distance required to walk in a particular hallway to get localized. The DTW was performed between each short test segment and sliding windowed segments of stored maps. The algorithm below explains this.

Based on the sampling rate, the time taken to walk a certain distance t was calculated as t=1/s. For samples of length Wₗ, t was calculated as Wₗ/s. The estimated distance was finally computed using δ=v*t, where v was approximately between 0.8-1.6 m/s. The classification accuracy was calculated as

A=#Correct matches/Tₚ (4)

The estimation error for every Wₗ was calculated as

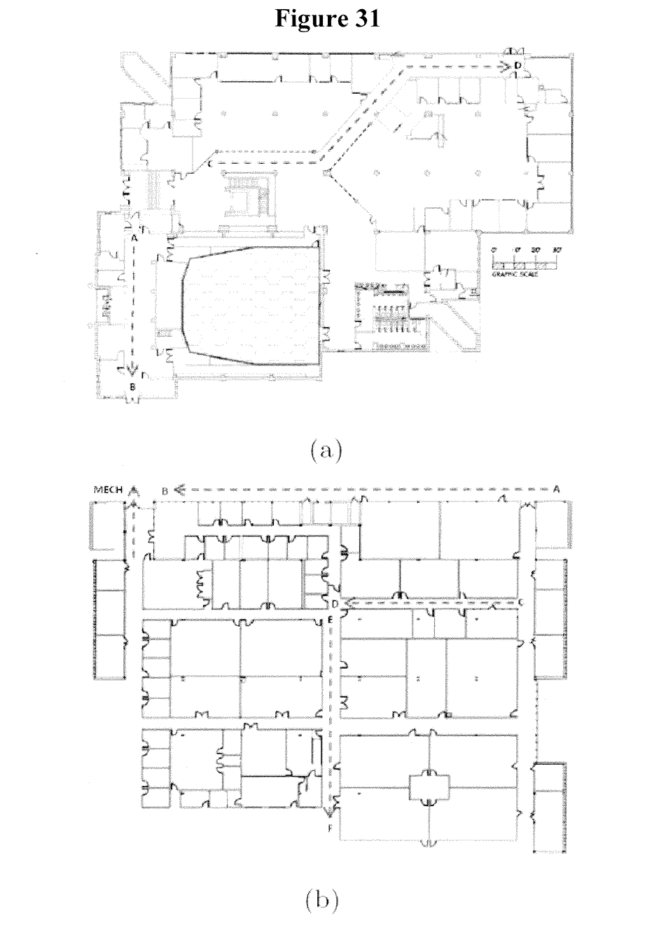

E=δ_{M}−δ_{E} (5)

where δ_{M} is the distance measured using a surveyor's wheel. Finally, the average estimation error over all positions δₑ for a particular Wₗ was calculated. FIG. 31 depicts the entire classification system. The inputs to the dynamic time warping blackbox are a test signature and signatures stored in the database. The classifier finds the best possible match between the two sequences and outputs an overall distance of the warping path. The decision module uses the nearest neighbor rule to chose the hallway that matched best.

### Example 10

### Localization Application and Implementation

LocateMe is an example of a localization application that runs on an Android smart phone to determine a user's location in a particular building. The application was written in Java using Android APIs and initially tested on the HTC Nexus One but it can be easily ported to other Android based smart phones which have a built-in magnetometer. LocateMe has three components: sensor sampling rate identifier, test signature collector, and hallway classifier.

The sampling rate identifier calculates the frequency of the magnetic field sensor in the Android phone being used. During preliminary data collection, it was noticed that different smart phones had different sampling rates. For this application to function properly, it is required to find the sampling rates in the phones. This process is performed automatically once the application is opened and requires no user interaction to complete (no user requirements). A splash screen can be used to perform this analysis. Finding this rate allows consistency in the user implementation.

The LocateMe application can also have a home screen. This screen contains the building selection drop down list. The user, assuming he/she knows which building they are in (which can also be obtained using GPS just before entering), picks the building from the list. Magnetic maps for the corresponding building are then downloaded onto the phone. The localization results will reflect the comparison of these stored maps with the test signature collected by the user. The test signature collector obtains the sensor data when the user pushes a Start Toggle button and walks a certain distance. Test signature collection can also be displayed.

After collecting the test signature, the user can push a Classify button. This is when the hallway classifier is activated and DTW works on the test and map data.

### Example 11

### Data Collection Methods for Localization

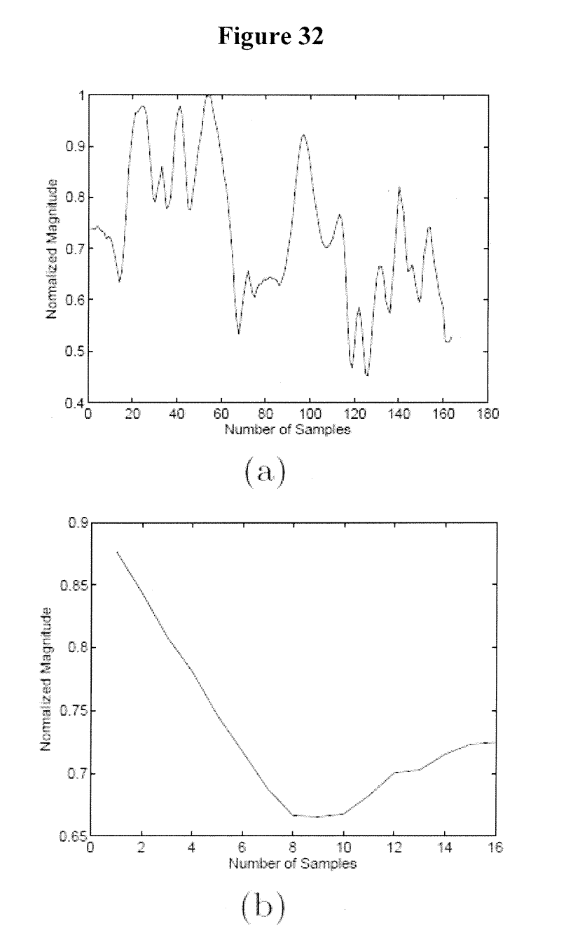

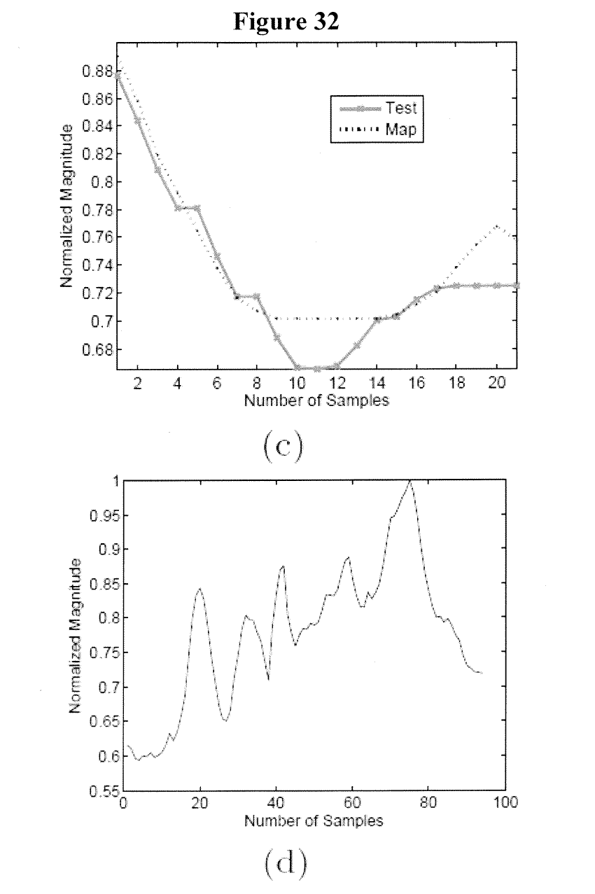

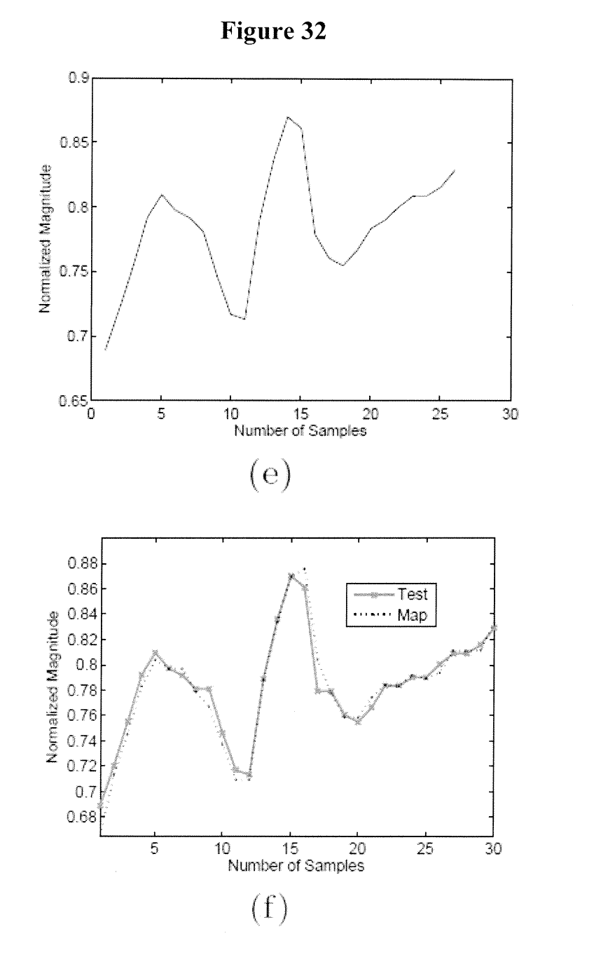

The fingerprint collection was performed in different hallways of two campus buildings, University Union and College of Engineering (COE). The floor maps in FIGS. 32(a) and 32(b) illustrate the different hallways. The hallways are narrow and one of them has an irregular shape.

Table 10 below summarizes the number of fingerprints collected in both of the buildings. The process was repeated at different times of a day for a period of three months with people walking around most of the time in the hallways.

TABLE 10
Data collection statistics

| | UU | COE |
|---|---|---|
| N_{hwys} | 6 | 4 |
| Fᵣ | 10 | 15 |
| HL_{avg} | 38 m | 51 m |
| Tr_{fs} | 12 Kb | 8 Kb |

In Table 10, N_{hwys} is the number of hallways, Fᵣ is the number of fingerprint repetitions, HL_{avg} is the average hallway length and T_{rfs} is the total training file size. Both the subjects walked with an average speed of 1.5 m/s along the corners rather than the center line. This was done for three main reasons 1) to obtain a dominant signature that could arise due to walls and ferromagnetic pillars, 2) mimic usual walking patterns of people, and 3) make the application useful for visually impaired people who follow a wall trailing procedure where they walk past walls holding or sensing the touch of pillars, doors, walls etc.

After confirming the reliability of the data using uncertainty analysis, the data was averaged from each subject to obtain an average fingerprint for each hallway from both the subjects. Further, the fingerprint from subject1 was considered as a test and subject2 was considered as map for evaluation.

### Example 12

### Data Analysis and Results for Localization

This example discusses the performance of the sliding windowed DTW algorithm, the classification accuracies, estimation errors and localization distances obtained. Next, these results are compared with a particle filter based approach (Haverinen et al. 2009). A comparative analysis is also provided of the response or result computation times, memory and power consumption of the algorithm on different smart phones.

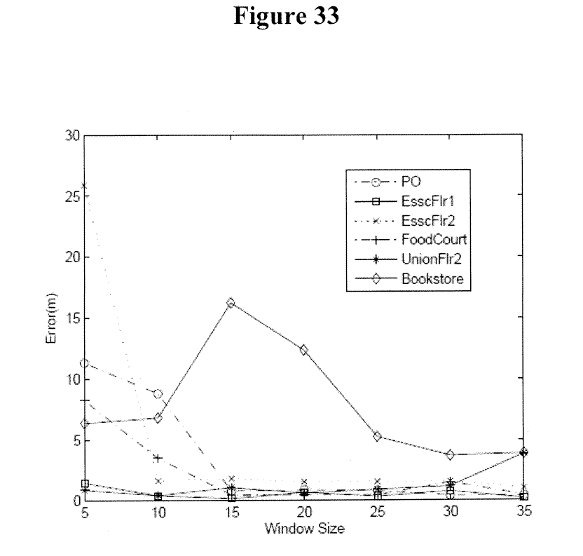

FIG. 33 illustrates the sliding windowed DTW on the measurement data. In FIG. 33, (a) and (d) are the maps, (b) and (e) are the short test signatures with 15-25 samples, and (c) and (f) are the test signatures matched to the correct segment in the map. Short segments of a test signature were randomly picked as explained above and DTW aligned these segments with windowed segments of the map, thereby matching the test signatures correctly to the respective map or hallway.

The estimation error was computed for each random position and averaged. FIG. 34 depicts the average estimation errors over all the positions chosen for every window size (resolution) in the COE hallway.

It can be seen that for five out of the six hallways, the error is between 0 and 3.5 m approximately. There are some outliers in the estimation errors such as 25.2 m for a Wₗ of five samples in the ESSCLvL2 and 17 m for 15 samples in the Bookstore hallways. The reason for this is very low resolution in those particular hallways for which DTW was unable to obtain a correct match. Moreover, there could have been segments of signatures that had a similar pattern as that of the test which resulted in the DTW performing a wrong match. However, for the remaining window sizes, the error reduced drastically to within 2 m and 5 m respectively for the two hallways.

From these error plots, it was analyzed which particular window size resulted in a high accuracy and low estimation error for every hallway. In other words, the lowest distance required to walk in a particular hallway was picked with a high accuracy and low estimation error. These statistics are listed in Tables 11 and 15.

The tables indicate the resolution (distance required to walk) within certain meters with a certain accuracy. For example, in Corr2 hallway, it is required to walk 2.32 m to be localized within 3 m with a 90% accuracy.

Next, results are compared with those obtained (tabulated in Table 13) from a particle filter based approach followed in Haverinen et al., 2009. This is the only existing work related to magnetic field based localization with humans. The experiment was conducted in a single hallway of length 278 m. The particle filter simulation program incremented the position of the human by 1 m thereby obtaining 278 positions for the entire hallway. Further, each experiment set was conducted using different values of standard deviation of the measurement model_r. between [1 μT, 5 μT]. The measurement model used was a single variable Gaussian probability density function given by

$$p ( z \vert x ) = \frac{1}{{σ}_{r} \sqrt{2 pi}} exp ( - \frac{( z - {\vert h ( x ) \vert}^{2} )}{2 {σ}_{r}^{2}} ) \qquad ( 6 )$$

where x is the state of the system, h(x) is the function to generate an observation z for state x.

From Tables 11 and 15, it can be seen that the minimum and maximum localization distance required to walk are 1.83 m and 6.3 m respectively. Although 6.3 m is a large distance, for most of the hallways, it was less than 5 m. This is a great improvement when compared to values between 9 m and 45 m shown in Table 13. The cause for large localization distances obtained using particle filters can be attributed to the fact that particles take a longer time or distances to converge due to deviations in the stored and the test signatures. In contrast, the DTW algorithm handles these deviations either by stretching or compressing the signatures.

Thus, it can be seen that Matlab based evaluation yielded very encouraging results. Next was evaluating the application implemented on the smartphones with different users.

The application was implemented and tested on Nexus One, Droid, Nexus S, HTC Hero and Samsung Captivate smartphones. 9 users were chosen for 9 hallways, one user per hallway. Users were instructed to walk 10 different positions in each hallway using different phones. They used the options provided in the user interface of the localization application. A screenshot of the results can show the classified hallway, position of the user in that hallway, and from a nearby landmark. The response time of the algorithm can also be shown.

In Gozick et al., 2011, it was shown how magnetic signatures can be used as landmarks. Using this information, the position of a user near certain landmarks can be given. There are also other means of extracting landmarks and integrating them with the fine localization results presented in this disclosure.

The average response times were calculated for each hallway and summed to obtain a total response time for the building. This response time is the total time spent by the user waiting from initially pushing the classify button to the time he/she receives a classification and estimated distance result. The response time however depends on the hardware specifications and processing capabilities of these smart phones. Some of the specifications are listed in Table 14. The response times obtained from each smart phone are illustrated in FIG. 14. By correlating the response times with the information from Table 14, it can be inferred that the faster the processor, faster the computation time.

TABLE 11
College of Engineering

| Hallway | A | σₑ | δₗ |
|---|---|---|---|
| Corr2 | 90 | 3.05 | 2.32 |
| Corr4 | 99 | 3.50 | 3.43 |
| Mech | 86 | 3.37 | 4.57 |
| CSE | 96 | 0.66 | 4.57 |

TABLE 12
University Union

| Hallway | A | σₑ | δₗ |
|---|---|---|---|
| Post Office | 90 | 0.79 | 2.2 |
| ESSCLvL1 | 100 | 0.33 | 4.57 |
| ESSCLvL2 | 80 | 1.62 | 1.83 |
| Foodcourt | 100 | 0.45 | 3.5 |
| UnionLvL2 | 90 | 1.17 | 5.5 |
| Bookstore | 90 | 3.67 | 6.3 |

TABLE 13
Particle filter based estimation

| σᵣ (μ) | σₑ (m) | δₗ (m) |
|---|---|---|
| 1.0 | 3.47 | 9.98 |
| 3.0 | 3.46 | 23.98 |
| 5.0 | 3.43 | 45.02 |

TABLE 14
Smartphones and their specifications

| | | Processor | | |
|---|---|---|---|---|
| Model | Processor Make | Speed | | RAM |
| Nexus One | Qualcomm QSD8250 | 1 | GHz | 512 MB |
| Droid | T1 OMAP3430 | 600 | MHz | 256 MB |
| Nexus S | Cortex A8 | 1 | GHz | 16 GB iNAND |
| | | | | flash memory |
| HTC Hero | Qualcomm MSM7200A | 528 | MHz | 288 MB |
| Samsung | Cortex A8 | 1 | GHz | 512 MB RAM |
| Captivate | | | | |

TABLE 15
Performance - Memory and Power Consumption

| Application | Memory (MB) | Power (mW) |
|---|---|---|
| Active Call | 1.14 | 327 |
| Game | 4.70 | POWER |
| LocateMe | 6.63 | 480 |
| Music | 13.66 | 250 |
| Navigation | 24.13 | 600 |
| System | 31.78 | 74 |

The Android smartphone allows external storage up to 32 GB which is useful for storing a set of magnetic maps for each building. As listed in Table 10, the size of the database is very small. With the storage space available on SD cards, a database file up to X hallway maps can be stored.

The amount of resources taken by the LocateMe localization application is also of interest. From the response times shown earlier, it is clear that LocateMe does not require more than 2 mins for all the three components explained above to run. So the memory usage of RAM in mega bytes and power consumed in mill Watts by this application was compared to other activities that normally run on a smartphone. The trials were run on a Nexus One since it has the better specifications than the other phones.

From the results obtained, the applicability of DTW to match signatures collected by different people and provide localization independent of the user and the hallway was shown.

There are some other differences between the two approaches. This work is a classification based approach, evaluated with no prior information about the test data. Whereas, the particle filter was validated on a known test data or hallway. Also only one hallway signature was used in the alternate experiment as opposed to a total of 9 in this work. Moreover, the proposed application was also validated with subjects completely new to the buildings. Hence it is practically feasible and can be used by anyone owning a smartphone (regardless of the position and orientation).

The fast response times and the low memory consumption of DTW on different phones shows the feasibility of using this classifier on mobile devices.

Creating and building a database of fingerprints is not a cumbersome task. After the construction of a building and before it is open for public, the fingerprints can be collected and stored. A crucial question that can be asked here is the effect of metal objects that can be moved, added or changed, on the magnetic field as time progresses. The time spent in fingerprinting hallways is very much less than that for following maintenance procedures like elevator servicing, emergency exit lighting etc.

Crowdsourcing is the concept that describes a distributed problem-solving and product model, in which small tasks are broadcasted to a crowd in the form of open calls for solutions. Everyday users engage in activities that help in solving or providing information for a larger context. This concept can be integrated with this work which involves mainly data collection around different hallways. In other words, the occupants of the building can collect magnetic signatures of different hallways since they usually move around the same set of locations daily, following routine paths and most of them carry smartphones. The data collected can be uploaded onto a server. This form of data collection and sharing can be also categorized as participatory sensing where users can passively participate in the sensing process since all that is required is to walk and collect data. Following these procedures, a database can be easily built and continuously updated providing accurate maps of the building.

### REFERENCES

The following documents and publications are hereby incorporated by reference.

### OTHER PUBLICATIONS

T. Brezmes, J.-L. Gorricho, and J. Cotrina, “Activity recognition from accelerometer data on a mobile phone,” in IWANN '09: Proceedings of the 10th International Work-Conference on Artificial Neural Networks. Berlin, Heidelberg: Springer-Verlag, 2009, pp. 796-799.
H. Huang and G. Gartner, “A survey of indoor navigation systems.”
E. W. Hill and P. Punder, Orientation and Mobility Techniques: A Guide for the Practitioner, 1st ed. American Foundation for the Blind, 1976, p. 119.
U. R. Roentgen, G. J. Gelderblom, M. Soede, and L. P. de Witte, “Inventory of electronic mobility aids for persons with visual impairments: A literature review.” Journal of Visual Impairment & Blindness, vol. 102, no. 11, pp. 702-724, 2008.
B. Dasarathy, “Sensor fusion potential exploitation-innovative architectures and illustrative applications,” Proceedings of the IEEE, vol. 85, no. 1, pp. 24-38, January 1997.
W. F. Storms and J. F. Raquet, “Magnetic field aided indoor navigation,” in Proceedings of the 13th European Navigation Conference GNSS, 2009.
Q. Ladetto and B. Merminod, “In Step with INS Navigation for the Blind, Tracking Emergency Crews,” GPS World, vol. 13, no. 10, pp. 30-38, 2002.
A. L. Liu, H. Hile, H. Kautz, G. Bordello. P. A. Brown, M. Harniss, and K. Johnson, “Indoor wayfinding: developing a functional interface for individuals with cognitive impairments,” in Assets '06: Proceedings of the 8th international ACM SIGACCESS conference on Computers and accessibility. New York, N.Y., USA: ACM, 2006, pp. 95-102.
S. Ram and J. Sharf, “The people sensor: A mobility aid for the visually impaired,” in ISWC '98: Proceedings of the 2nd IEEE International Symposium on Wearable Computers. Washington, D.C., USA: IEEE Computer Society, 1998, p. 166.
L. Ojeda and J. Borenstein, “Non-gps navigation with the personal dead-reckoning system,” G. R. Gerhart, D. W. Gage, and C. M. Shoemaker, Eds., vol. 6561, no. 1. SPIE, 2007.
K. Wendlandt, M. Kinder, M. Angermann, and P. Robertson, “Continuous location and direction estimation with multiple sensors using particle filtering,” in Multisensor Fusion and Integration for Intelligent Systems, 2006 IEEE International Conference on September 2006, pp. 92-97.
R. G. Golledge, Klatzky, R. L. Klatzky, Loomis, J. Speigle, and J. Tietz, “A geographical information system for a gps based personal guidance system,” 1998.
R. Golledge, J. R. Loomis, J. M. Klatzky, and R. L. Klatzky, “Stated preferences for components of a personal guidance system for nonvisual navigation,” Journal of Visual Impairment & Blindness, no. 3, pp. 135-147, 2004.
A. Helal, S. E. Moore, and B. Ramachandran, “Drishti: an integrated navigation system for visually impaired and disabled,” in Wearable Computers, 2001. Proceedings. Fifth International Symposium on, 2001, pp. 149-156.
D. A. Ross and B. B. Blasch, “Wearable interfaces for orientation and wayfinding,” in Assets '00: Proceedings of the fourth international ACM conference on Assistive technologies. New York, N.Y., USA: ACM, 2000, pp. 193-200.
O. Woodman and R. Harle, “Pedestrian localisation for indoor environments,” in UbiComp '08: Proceedings of the 10th international conference on Ubiquitous computing. New York, N.Y., USA: ACM, 2008, pp. 114-123.
B. Krach and P. Roberston, “Integration of foot-mounted inertial sensors into a bayesian location estimation framework,” pp. 55-61, 2008, iD: 1.
V. Fox, J. Hightower, L. Liao, D. Schulz, and G. Borriello, “Bayesian filtering for location estimation,” Pervasive Computing, IEEE, vol. 2, no. 3, pp. 24-33, July-September 2003.
J. Hightower and G. Borriello, “Particle filters for location estimation in ubiquitous computing: A case study,” September 2004.
J. Raper, G. Gartner, H. Karimi, and C. Rizos, “Applications of location based services: a selected review,” Journal of Location Based Services, vol. 1, 2007.
W. Roy, A. Hopper, V. Falcao, and J. Gibbons, “The active badge location system,” ACM Trans. Inf. Syst., vol. 10, no. 1, pp. 91-102, 1992.
P. Bahl, and V. N. Padmanabhan, “Radar: An in-building rf-based user location and tracking system,” in IEEE INFOCOM 2000, 2000, pp. 775-784.
P. B. Nissanka, A. Chakraborty, and H. Balakrishnan, “The cricket location-support system,” in MobiCom '00: Proceedings of the 6th annual international conference on Mobile computing and networking. New York, N.Y., USA: ACM Press, 2000, pp. 32-43.
P. B. Nissanka, K. Allen, H. H. Balakrishnan, and S. Teller, “The cricket compass for context-aware mobile applications,” in MobiCom '01: Proceedings of the 7th annual international conference on Mobile computing and networking. New York, N.Y., USA: ACM, 2001, pp. 1-14.
J. Hightower and G. Borriello, “A survey and taxonomy of location systems for ubiquitous computing,” IEEE Computer, Tech. Rep., 2001.
J. M. Loomis, R. L. Klatzky, R. G. Golledge, J. G. Cicinelli, J. W. Pellegrino, and P. A. Fry, “Nonvisual navigation by blind and sighted: Assessment of path integration ability,” Journal of Experimental Psychology: General, vol. 122, no. 1, pp. 73-91, 1993.
R. Golledge, Wayfinding Behavior—Cognitive Mapping and Other Spatial Processes. Johns Hopkins University Press.
M. Raubal, “Human wayfinding in unfamiliar buildings: a simulation with a cognizing agent,” Cognitive Processing, no. 2-3, pp. 363-388, 2001.
M. S. Arulampalam, S. Maskell, N. Gordon, and T. Clapp, “A tutorial on particle filters for on-line non-linear/non-gaussian Bayesian tracking,” IEEE Transactions on Signal Processing, vol. 50, pp. 174-188, 2001.
A. Doucet, S. Godsill, and C. Andrieu, “On sequential monte carlo sampling methods for bayesian filtering,” STATISTICS AND COMPUTING, vol. 10, no. 3, pp. 197-208, 2000.
P. M. Fitts, “The information capacity of the human motor system in controlling the amplitude of movement. 1954.” J Exp Psychol Gen, vol. 121, no. 3, pp. 262-269, September 1992.
Haverinen J, Kemppainen A (2009), “Global indoor self-localization based on the ambient magnetic field”, Robot Auton. Syst. 57.
Navarro D. Benet G (2009), “Magnetic map building for mobile robot localization purpose”, In Proceedings of the 14th IEEE international Conference on Emerging Technologies & Factory Automation (Palma de Mallorca, Spain) IEEE Press, Piscataway, N.J., 1742-1745.
Yamazaki K. Kawamoto T (2001), “Simple estimation of equivalent magnetic dipole moment to characterize ELF magnetic fields generated by electric appliances incorporating harmonics,” IEEE Transactions on Electromagnetic Compatibility, vol. 43, no. 2, pp. 240-245.
Suksakulchai S. Thongchai S, Wilkes D M, Kawamura K (2000), “Mobile Robot Localization using an Electronic Compass for Corridor Environment”, Proceedings of the IEEE International Conference on Systems, Man and Cybernetics, Nashville, Tenn., USA.
Rahok S A, Koichi O (2009), “Odometry correction with localization based on landmarkless magnetic map for navigation system of indoor mobile robot,” 4th International Conference on Autonomous Robots and Agents, ICARA 2009, pp. 572-577.
Hashimoto, H.; Magatani, K.; Yanashima, K.; “The development of the navigation system for visually impaired persons,” Engineering in Medicine and Biology Society, 2001. Proceedings of the 23rd Annual International Conference of the IEEE, vol. 2, no., pp. 1481-1483 vol. 2, 2001.
Oldenburg C, Moridis G (1998), “Ferrofluid Flow for TOUGH2,” Lawrence Berkeley Laboratory Report LBL-41608, Berkeley, Calif.
McCaig M, Clegg, A. G. (1987), “Permanent Magnets in Theory and Practice,” 2nd ed. Halsted Press, Div, of J. Wiley & Sons, New York, N.Y., 1987.
Storms W F, Raquet J F (2009), “Magnetic Field Aided Indoor Navigation,” in Proc. 13th European Navigation Conference GNSS.
Asahi-kasei. URL http://http://www.asahikasci.co.jp/asahi/en/news/2006/e070313.html
Chromosome classification using dynamic time warping. Pattern Recognition Letters 29(3), 215-222 (2008)
Alt, F., Shirazi, A. S., Schmidt, A., Kramer, U., Nawaz, Z.: Location-based crowdsourcing: extending crowdsourcing to the real world. In: Proceedings of the 6th Nordic Conference on Human-Computer Interaction: Extending Boundaries, NordiCHI '10, pp. 13-22. ACM, New York, N.Y., USA (2010)
Ann, C., Keogh, R. E.: Abstract three myths about dynamic time warping data mining (2005)
Azizyan, M., Choudhury, R. R.: Surroundsense: Mobile phone localization using ambient sound and light. SIGMOBILE Mob. Comput. Commun. Rev. 13, 69-72 (2009)
Bucur, D., Kjrgaard, M.: GammaSense: Infrastruetureless Positioning Using Background Radioactivity, Smart Sensing and Context, vol. 5279, pp. 69-82. Springer Berlin/Heidelberg (2008)
Burke, J., Estrin, D., Hansen, M., Parker, A., Ramanathan, N., Reddy, S., Srivastava, M. B.: Participatory sensing. In: In: Workshop on World-Sensor-Web (WSW06): Mobile Device Centric Sensor Networks and Applications, pp. 117-134 (2006)
Cheng, Y. C., Chawathe, Y., LaMarca, A., Krumm, J.: Accuracy characterization for metropolitan-scale wi-fi localization. In: Proceedings of the 3rd international conference on Mobile systems. Applications, and Services, MobiSys '05, pp. 233-245. ACM, New York, N.Y., USA (2005)
Collin, J., Mezentsve, O., Lachapelle, G.: Indoor positioning system using accelerometry and high accuracy heading sensors. In: Proceedings of the 16th International Technical Meeting of the Satellite Division of the Institute of Navigation ION GPS/GNSS, pp. 796-799 (2003)
Constandache, I., Bao, X., Azizyan, M., Choudhury, R. R.: Did you see bob?: human localization using mobile phones. In: Proceedings of the sixteenth annual international conference on Mobile computing and networking, MobiCom, pp. 149-160. ACM, New York, N.Y., USA (2010)
Eagle, N.: txteagle: Mobile crowdsourcing. In: N. Aykin (ed.) Internationalization, Design and Global Development, Lecture Notes in Computer Science, vol. 5623, pp. 447-456. Springer Berlin/Heidelberg (2009)
Evennou, F., Marx, F.: Advanced integration of wifi and inertial navigation systems for indoor mobile positioning. EURASIP J. Appl. Signal Process. 2006, 164-164 (2006)
Gayathri, C, Tarn, V., Alexander, V., Marco, G., Rich, M., Jie, Y., Yingying, C.: Tracking vehicular speed variations by warping mobile phone signal strengths. In: IEEE International Conference on Pervasive Computing and Communications (PERCOM), 2011 (2011)
Golding, A. R., Lesh, N.: Indoor navigation using a diverse set of cheap, wearable sensors. Wearable Computers, The Third International Symposium on pp. 29-36 (1999)
Gozick, B., Pathapati-Subbu, K., Dantu, R. Maeshiro, T.: Magnetic maps for indoor navigation. IEEE Trans. Instrum. Meas. (2011). URL http://nsl.unt.edu/kalyan/TIM2147690.pdf. Accepted for publication
Grzonka, S., Dijoux, F., Karwath, A., Burgard, W.: Mapping indoor environments based on human activity. In: Robotics and Automation (ICRA), 2010 IEEE International Conference on, pp. 476-481 (2010). DOI 10.1109/ROBOT.2010.5509976
Haavisto, M., Tuominen, S., Kankaanpa and a and, H., Paju, M.: Time dependence of demagnetization and flux losses occurring in sintered nd-fe-b permanent magnets. Magnetics, IEEE Transactions on 46(9), 3582-3584 (2010). DOI 10.1109/TMAG.2010.2047262
Lee, S. W., Mase, K.: Activity and location recognition using wearable sensors. Pervasive Computing, IEEE 1; 1(3), 24-32 (2002)
Liu, H., Darabi, H., Banerjee, P., Liu, J.: Survey of wireless indoor positioning techniques and systems. Systems, Man, and Cybernetics, Part C: Applications and Reviews, IEEE Transactions on 37(6), 1067-1080 (2007). DOI 10.1109/TSMCC.2007.905750
Muscillo, R., Conforto, S., Schmid, M., Caselli, P., D'Alessio, T.: Classification of motor activities through derivative dynamic time warping applied on accelerometer data. In: Engineering in Medicine and Biology Society, EMBS 2007, 29th Annual International Conference of the IEEE, pp. 4930-4933 (2007)
Niennattrakul, V., Ratanamahatana, C: On clustering multimedia time series data using k-means and dynamic time warping. In: Multimedia and Ubiquitous Engineering, 2007. MUE '07. International Conference on, pp. 733-738 (2007)
Ofstad, A., Nicholas, E., Szcodronski, R., Choudhury, R. R.: Aampl: Accelerometer augmented mobile phone localization. MELT'08 San Francisco, Calif., USA. (2008)
Parnandi, A., Le, K., Vaghela, P., Kolli, A., Dantu, K., Poduri, S., Sukhatme, G. S.: Coarse in-building localization with smartphones. In: Mobile Computing, Applications, and Services, Lecture Notes of the Institute for Computer Sciences, Social Informatics and Telecommunications Engineering, vol. 35, pp. 343-354. Springer Berlin Heidelberg (2010)
Pathapati-Subbu, K., Xu, N., Dantu, R.: iknow where you are. In: Social Intelligence and Networking International Symposium 2009, IEEE (2009)
Randall, J., Amft, O., Bohn, J., Burri. M.: Luxtrace: indoor positioning using building illumination (2007)
Ravi, N., Iftode, L.: Fiatlux: Fingerprinting rooms using light intensity (2007)
Ravi, N., Shankar, P., Frankel, A., Elgammal, A., Iftode, L.: Indoor localization using camera phones. In: Mobile Computing Systems and Applications, 2006. WMCSA '06. Proceedings. 7th IEEE Workshop on, p. 19 (2006). DOI 10.1109/WMCSA.2006.11
Sakoe, H., Chiba, S.: Dynamic programming algorithm optimization for spoken word recognition. Acoustics, Speech and Signal Processing, IEEE Transactions on 26(1), 43-49 (1978)
Sheinker, A., Frumkis, L., Ginzburg, B., Salomonski, N., Kaplan, B. Z.: Magnetic anomaly detection using a three-axis magnetometer. Magnetics, IEEE Transactions on 45(1), 160-167 (2009). DOI 10.1109/TMAG.2008.2006635
Tuzcu, V., Nas, S.: Dynamic time warping as a novel tool in pattern recognition of ecg changes in heart rhythm disturbances. In: Systems, Man and Cybernetics, 2005 IEEE International Conference on, vol. 1, pp. 182-186 Vol. 1 (2005). DOI 10.1109/ICSMC.2005.1571142
Varshavsky, A., LaMarca, A., Hightower, J., de Lara, E.: The skyloc floor localization system. In: Pervasive Computing and Communications, 2007. PerCom '07. Fifth Annual IEEE International Conference on, pp. 125-134 (2007). DOI 10.1109/PERCOM.2007.37
Vildjiounaite, E., Malm, E. J., Kaartinen, J., Alahuhta, P.: Location estimation indoors by means of small computing power devices, accelerometers, magnetic sensors, and map knowledge. In: F. Mattern, M. Naghshineh (eds.) Pervasive Computing, Lecture Notes in Computer Science, vol. 2414, pp. 5-12. Springer Berlin/Heidelberg (2002)
Want, R., Hopper, A., Falcao, V., Gibbons, J.: The active badge location system. ACM Trans. Inf. Syst. 10, 91-102 (1992)
Youssef, A., Abdel-Galil, T., El-Saadany, E., Salama, M.: Disturbance classification utilizing dynamic time warping classifier. Power Delivery, IEEE Transactions on 19(1), 272-278 (2004). DOI 10.1109/TPWRD.2003.820178

What is claimed is:

1. A method for navigating inside a building by a person using a smartphone, wherein the smartphone is equipped with one or more sensors and a navigation software platform, comprising:
specifying a desired destination by entering the desired destination into the navigation software platform of the smartphone, wherein the smartphone carries out the following steps in response:
calculating the person's present location inside the building,
calculating the distance between the person's present location and the desired destination,
generating one or more possible routes through the building to the desired destination, and
providing directions to the person to reach the desired destination; and
following the directions provided by the smartphone until the desired destination is reached.

2. The method of claim 1, wherein the smartphone carries out the step of calculating the person's present location inside the building at various times in order to update the present location and provide updated directions to the person to reach the desired destination.

3. The method of claim 1, wherein the smartphone provides directions to the person to reach the desired destination by generating periodic alerts containing additional directions.

4. The method of claim 3, wherein the periodic alerts are audio based alerts.

5. The method of claim 3, wherein the periodic alerts are timed to take into account the person's tendencies to overestimate and underestimate distance and trajectory.

6. The method of claim 1, wherein the sensors of the smartphone comprise an accelerometer, a compass, and a magnetometer.

7. The method of claim 6, wherein the smartphone utilizes data recorded by the sensors to calculate acceleration, distance, trajectory, and magnetic field strength in order to calculate the person's present location inside the building, calculate the distance between the person's present location and the desired destination, generate one or more possible routes through the building to the desired destination, and provide directions to the person to reach the desired destination.

8. The method of claim 1, wherein the sensors of the smartphone comprise a magnetometer, wherein the smartphone further comprises a database of magnetic maps of the building, and wherein the smartphone utilizes the magnetometer and one or more magnetic maps in the database in order to calculate the person's present location inside the building, calculate the distance between the person's present location and the desired destination, generate one or more possible routes through the building to the desired destination, and provide directions to the person to reach the desired destination.

9. A system for navigating to a desired destination inside a building by an individual, comprising:
a smartphone equipped with one or more sensors, wherein the smartphone comprises:
a map database comprising stored magnetic maps of building interiors;
a software platform for activating the sensors and providing an interface with the individual for entering the desired destination and receiving directions;
a sensor data acquisition module for collecting and pre-processing raw data obtained from the sensors;
a data fusion module for using pre-processed data from the sensor data acquisition modules to produce estimates of distance and the individual's location;
a map matching module for comparing the estimates of location from the data fusion module to the stored magnetic maps to identify the individual's location inside a building;
a navigation module for generating routes to the desired destination and providing directions to the individual.

10. The system of claim 9, wherein the sensors of the smartphone comprise an accelerometer, a compass, and a magnetometer.

11. The system of claim 10, wherein the sensors of the smartphone further comprise a tactile sensor comprising a communication means for sending data to the smartphone.

12. The system of claim 9, wherein the smartphone further comprises a signal processing filter for processing data recorded by the sensors.

13. The system of claim 9, wherein the data fusion module utilizes particle filter algorithms to estimate distance and location.

14. The system of claim 9, wherein the data fusion module utilizes fused sensor data to estimate distance and location.

15. A method for generating a magnetic map of an interior of a building having structural landmarks for use in indoor navigation, comprising:
activating a magnetometer of a smartphone to record magnetic field variations;
moving the smartphone past various locations of the structural landmarks in the building;
recording magnetic field variations using the magnetometer at the various locations in the building;
equating the recorded magnetic field variations with the structural landmarks of the building; and
generating a magnetic map of the interior of the building showing the landmarks and their recorded magnetic fields.

16. The method of claim 15, further comprising the step of storing the generated magnetic map in a database on the smartphone.

17. A method for localization inside a building by a person using a smartphone, wherein the smartphone is equipped with one or more sensors, a software platform, and a stored database of magnetic maps for various buildings, comprising:
specifying a selected building by entering the building name into the navigation software platform of the smartphone;
activating the software platform;
moving the smartphone on a path through the building, wherein the smartphone carries out the following steps in response:
loading the magnetic map for the selected building,
recording a magnetic test signature based on the path moved through the building using the sensors,
performing dynamic time warping (“DTW”) to align the test signature with a corresponding portion of the magnetic map,
identifying the corresponding portion of the magnetic map that best matches the test signature,
using the identified portion of the magnetic map to identify the person's location inside the building, and
communicating the person's location to the person using the software platform.

18. The method of claim 17, wherein the smartphone further carries out the step of estimating the person's distance traveled inside the building.

19. The method of claim 17, wherein the software platform utilizes a nearest neighbor rule to identify the corresponding portion of the magnetic map that best matches the test signature.

20. A system for localization inside a building by an individual, comprising:
a smartphone equipped with one or more sensors, wherein the smartphone comprises:
a map database comprising stored magnetic maps of building interiors;
a software platform for activating the sensors and providing an interface with the individual;
a sensor data acquisition module for collecting and normalizing raw data obtained from the sensors;
a data fusion module for using normalized data from the sensor data acquisition modules to produce a test signature reflecting the individual's movement through the building;
a classifier module for performing dynamic time warping (“DTW”) to align the test signature with a corresponding portion of a magnetic map; and
a decision module for identifying the corresponding portion of the magnetic map that best matches the test signature and for identifying the person's location inside the building.

21. The system of claim 20, wherein the sensors of the smartphone comprise an accelerometer, a compass, and a magnetometer.
